(19) United States
(12) Patent Application Publication
(10) Pub. No.: US 2012/0109530 A1
(43) Pub. Date: May 3, 2012

(54) METHOD OF CLASSIFYING CHEMICALLY CROSSLINKED CELLULAR SAMPLES USING MASS SPECTRA

(76) Inventor: Patrick J. Parks, Mendota Heights, MN (US)

(21) Appl. No.: 13/287,473

(22) Filed: Nov. 2, 2011

Related U.S. Application Data
(63) Continuation-in-part of application No. 11/917,439, filed on Oct. 13, 2009.
(60) Provisional application No. 60/691,182, filed on Jun. 16, 2005.

(51) Int. Cl. G06F 19/00

(52) U.S. Cl. 702/19

(57) ABSTRACT

A method of analyzing cellular samples, particularly gastrointestinal cellular samples, that include a chemically crosslinked analyte is provided. The analysis typically involves the use of mass spectrometry. The methods described herein may be used to identify biomarkers associated with disease as well as to provide risk assessment for developing disease.

### CROSS-REFERENCE TO RELATED APPLICATIONS

This application is a Continuation-in-Part of U.S. application Ser. No. 11/917,439, filed Oct. 13, 2009, currently pending, which is a National Stage Entry of PCT/US2006/023594, filed Jun. 16, 2006, now expired, which claims priority to U.S. Provisional Application No. 60/691,182, filed Jun. 16, 2005, now expired. The entire contents of all are hereby incorporated by reference.

### BACKGROUND

Microscopic examination and histopathologic diagnosis of both human and animal tissues has aided in the accuracy of medical diagnosis and treatment, as well as the advancement of research into diseases and their potential treatments. Advances in analytical techniques have provided the opportunity to understand the cellular mechanisms of disease and to select appropriate treatments. The identification of molecular markers of disease, such as tumor-specific antigens, has enabled diagnostic and prognostic assays to be developed that rely on the use of molecular probes (e.g., antibodies and nucleic acid probes) to detect these markers.

Identifying novel markers is one of the earliest and most difficult steps in the diagnostics and drug discovery processes. One way to discover if substances are markers for a disease is by determining if they are “differentially expressed” in biological samples from patients exhibiting the disease as compared to samples from patients not having the disease. For example, in mass spectra of samples comparing a group of diseased patients and normal patients, the average intensity of the generated signals at the mass-to-charge ratio A is higher in the samples from diseased patients than the samples from the normal patients. The marker at the mass-to-charge ratio A is said to be “differentially expressed” in diseased patients, because the concentration of this marker is, on average, greater in samples from diseased patients than in samples from normal patients. Since the concentration of the marker is generally greater in samples from diseased patients than in the normal samples, the marker can also be characterized as being “up-regulated” for the disease. If the concentration of the marker was generally less in the samples from diseased patients than in the samples from normal patients, the protein could be characterized as being “down-regulated”.

Once markers are discovered, they can be used as diagnostic tools. For example, with reference to the example described above, an unknown sample from a test patient may be analyzed using a mass spectrometer and a mass spectrum can be generated. The mass spectrum can be analyzed and the intensity of a signal at the mass-to-charge ratio A can be determined in the test patient's mass spectrum. The signal intensity can be compared to the average signal intensities at the mass-to-charge ratio A for diseased patients and normal patients. A prediction can then be made as to whether the unknown sample indicates that the test patient has or will develop cancer. For example, if the signal intensity at the mass-to-charge ratio A in the unknown sample is much closer to the average signal intensity at the mass-to-charge ratio A for the diseased patient spectra than for the normal patient spectra, then a prediction can be made that the test patient is more likely than not to develop or have the disease.

When a large number of mass spectra of a large number of biological samples are analyzed, it is not readily apparent which signals represent markers that might differentiate between a diseased state and a non-diseased state. A typical mass spectrum of a biological sample has numerous potential marker signals (e.g., greater than 200) and a significant amount of noise. This can make the identification of potentially significant signals and the identification of average signal differentials difficult. Consequently, it is difficult to identify and quantify potential markers. Unless the potential markers exhibit strong up-regulation or strong down-regulation, the average signal differential between samples from diseased patients and samples from normal patients may not be easily discernable.

While the described differential expression analysis is useful, the samples used to generate the mass spectra have excluded formalin-fixed paraffin-embedded tissue. DNA has been isolated from paraffin embedded tissue specimens following chemical fixation, typically with formalin. However, the methods involved in the formation of paraffin sections have heretofore excluded these sections from most of the molecular analytic methods, including mass spectrometry.

Historically, formalin fixation has been used with tissue in order to provide optimal specimen preservation for light microscopic examination of the preserved tissue. Chemical fixation with aldehydes is associated with denaturation that results from the crosslinking of pendant reactive amines. Formalin fixation results in methylene bridges between and among proteins, effectively reducing or removing the tertiary structure required for immune detection of proteins. Further, paraffin embedding is carried out at temperatures that can cause the loss of tertiary structure of the proteins thereby forming unfolded, but intact, proteins, reducing or removing enzymatic activity where it exists as well as removing, the structures (epitopes) required for immune detection.

Standard histological staining methods such as haematoxylin and eosin (HScE or H&E) generally can reveal only a limited amount of information. Current methods of microscopic evaluation can be extended to include such methods as morphometry, immunohistochemistry, in situ hybridization, etc. The identification and development of new clinically important molecular markers has been impeded by the slow and tedious process of determining the expression of these markers in large numbers of clinical specimens.

The natural progression of the data from the human genome project has been from single gene to multiple genes (genomics) and subsequently to identifying all proteins (proteomics) simultaneously. While “protein chips” carry the potential to measure concentrations, and perhaps function, at present immunohistochemistry is the only method capable of localization. Localization by immunohistochemistry is qualitative by nature, and semiquantitative at best using subjective evaluation by trained evaluators.

The ability to identify potential drug targets for potential treatment using immunohistochemistry has been amplified by the use of tissue microarrays (TMAs), a technology that involves the placement of many, typically 500 to 1000, tissue samples on a single microscope slide. Methods of grouping multiple tissue specimens on a single substrate have relied on manually cutting multiple paraffin-embedded tissue specimens and forming them into a composite block (see, e.g., Battifora et al., 1986, Lab. Invest. 55: 244-248; U.S. Pat. No. 4,820,504) or into “straws” or “logs” from which transverse sections could be obtained (see, e.g., Wan et al., 1987, J. Immunol. Meth. 103: 121-129; U.S. Pat. No. 4,914,022; Miller and Groothuis, 1991, A.J.C.P. 96: 228-232); and Kononen et al., 1998, Nat. Med. 4: 844-7, which describes a technique for generating tissue arrays comprising hundreds of tumor specimens using punched samples from archival tissue blocks.

Tissue microarrays have the capacity to measure insoluble, large proteins such as extracellular matrix proteins, currently unavailable for analysis with standard mass spectrometric methods. Additionally, tissue microarrays complement protein microarrays, which have the potential to measure soluble proteins. However, a major difficulty with TMAs is the limited amount of data that comes with each “histospot” (the 0.15 cm diameter tissue section spotted onto the microarray).

Tissue microarrays represent the tissue equivalent of DNA arrays and protein arrays. The concept of having more than one tissue on a glass slide is old, but the idea of arranging specific samples in a fixed array by using subsets of already existing tissues only was described in 1998 [Kononen, J., Bubendorf, L., Kallioniemi, A., Barlund, M., Schraml, P., Leighton, S., Torhorst, J., Mihatsch, M. J., Sauter G., Kallioniemi, O. P., Tissue microarrays for high-throughput molecular profiling of tumor specimens. Nat. Med. 1998, 4: 844-847.]. Most of the TMAs used to date have been malignant tumors, in part because they represent a major reservoir of tissue since all patients with putative tumors must have a tissue diagnosis in order to begin therapy and in part because the problems of cancer treatment have been so intractable. Approximately 2-4% of all patients (about 50,000) in the United States with cancer fail to have a primary tumor identified. These patients receive therapy for their cancers on an empirical basis. The ability to use their tissue samples taken for the diagnosis of malignancy in order to identify the origin of the malignancy will determine their therapy.

TMAs are available for a variety of tissue types, including tissues of the gastrointestinal (GI) system. The GI system, sometimes referred to as the digestive system or alimentary canal, is a highly organized system of organs and glands responsible for taking in food and other liquids and breaking them down into simpler molecules (sugars, amino acids, fatty acids) that can be absorbed into the bloodstream. The GI system is effectively a tube that is sub-divided into two parts, the upper digestive tract (including the mouth, pharynx, esophagus and stomach) and the lower digestive tract (including the bowel or small intestine and the large intestine).

There are a large and varied number of diseases and disorders of the GI system. These may be general GI diseases or disorders (e.g., Crohn's disease) or diseases and disorders specific to particular GI organs or glands, such as esophageal diseases (e.g., gastroesophageal reflux disease (GERD), Barrett's esophagus), stomach diseases (gastritis, peptic ulcer), or disorders of the bowel (colitis). Diseases and disorders of the GI tract include cancers, including malignant conditions of the esophagus, stomach, liver, biliary system, pancreas, bowels, and anus.

Cancer that originates in the tissues lining the stomach is known as gastric cancer. Gastric cancer is the second most common cause of cancer-related deaths in the world (National Cancer Institute, Fact Sheet, “Helicobacter pylori and Cancer”, Feb. 14, 2011). It can begin in any part of the stomach and spread, including to other organs of the GI tract. The site of stomach cancer is classified on the basis of its relationship to the long axis of the stomach. Gastric cardia cancer occurs in the top portion of the stomach near the junction of the esophagus, while non-cardia gastric cancer includes cancers in all other areas of the stomach. The most common (90%) gastric cancer is adenocarcinoma. Other cancers can affect the stomach but are more rare, including soft tissue sarcomas, mucosa associated lymphoid tissue (MALT) lymphomas, and carcinoid tumors.

Helicobacter pylori (H. pylori) is a gram negative bacteria found in the stomach. Most people (over 80%) colonized with H. pylori show no symptoms of infection. Symptomatic, acute infection typically involves acute gastritis with stomach pain or nausea. In certain instances, H. pylori infection can lead to a number of other diseases and disorders including chronic gastritis, peptic ulcer or stomach cancer, with inflammation playing an important role (Shiotani A, Graham D Y (November 2002). “Pathogenesis and therapy of gastric and duodenal ulcer disease”. Med. Clin. North Am. 86 (6): 1447-66, viii).

H. pylori infection has been associated with an increased risk for gastric cancer, including MALT (NCI, Feb. 14, 2011). The risk for non-cardia gastric cancer was increased 6-fold in H. pylori infected individuals in one 2001 study (Helicobacter and Cancer Collaborative Group, “Gastric cancer and Helicobacter pylori: a combined analysis of 12 case control studies nested within prospective cohorts”, Gut 2001; 49(3):347-353). Another study found an 8-fold increased risk for non-cardia gastric cancer (Kamangar, F., et al., “Opposing risks of gastric cardia and noncardia gastric adenocarcinomas associated with Helicobacter pylori seropositivity”, Journal of the National Cancer Institute 2006; 98(20):1445-1452). The risk for developing MALT lymphoma is 6-fold higher in individuals infected with H. pylori (Parsonnet, J., et al., “Helicobacter pylori infection and gastric lymphoma”, NEJM 1994; 330(18):1267-1271; Sagaert X., et al., “Gastric MALT lymphoma: a model of chronic inflammation-induced tumor development”, Nature Reviews Gastroenterology & Hepatology 2010; 7(6):336-346).

Since H. pylori is a common infection in man (the CDC estimates that ⅔ of the global population carries H. pylori (National Cancer Institute, Fact Sheet, “Helicobacter pylori and Cancer”, Feb. 14, 2011)), and because infection may produce diverse results (no impact, varying degrees of negative impact and—in certain instances—even positive impact on health), it would be advantageous to identify biomarkers in H. pylori infected populations that are associated with negative disease states, including cancer-associated biomarkers. Because of this wide spectrum of possibilities, cancer-associated biomarker identification would greatly assist in risk stratification of infected populations. Furthermore, since H. pylori may provide a clinical benefit to a subset of infected individuals, cancer biomarker identification is even more desirable. Some studies have shown a decreased risk of esophageal adenocarcinoma (EAC) in H. pylori infected individuals and have postulated that the bacterium's reduction of stomach acidity may be a factor in this lowered risk (National Cancer Institute, Fact Sheet, “Helicobacter pylori and Cancer”, Feb. 14, 2011; McNeil, C. “Helicobacter pylori: good side complicates efforts to combat bad side”, JNCI 2008; 100(24):1748-1750). In these instances, complete eradication of the bacteria may not be desirable if no risk for cancer exists.

Some biomarkers have been identified that, when present, may increase the infected individual's risk for gastric cancer. The presence of the homB gene in H. pylori infected tissue samples has been identified as a gastric cancer biomarker that may distinguish between gastric cancer and duodenal ulcer (Jung, S., et al., “HomB status of Helicobacter pylori as a novel marker to distinguish gastric cancer from duodenal ulcer” JCM 2009; 47(10):3241-3245). Although possibly more than a simple biomarker, Cag-A positive strains of H. pylori have been associated with an increased risk for non-cardia gastric cancer (National Cancer Institute, Fact Sheet, “Helicobacter pylori and Cancer”, Feb. 14, 2011). Cag-A is a toxin produced by the bacteria to improve adherence to the stomach and has been shown to lead to chronic inflammation of the tissue.

A need exists to rapidly identify biomarkers associated with diseases and disorders of the gastrointestinal tract. A more specific need exists to rapidly identify biomarkers associated with cancers of the GI system, including stomach cancer in H. pylori infected populations. As biomarker analysis often involves large volumes of data, a high throughput system is also desirable to ensure that results may be obtained rapidly.

It is thus an object of the present invention to provide a method to identify biomarkers associated with disorders of the gastrointestinal tract.

It is a further object of the present invention to provide a method to identify biomarkers specifically associated with GI cancer, including gastric cancer, in the population generally, and in H. pylori infected patients particularly.

It is a further object of the present invention to provide a method for assessing risk for developing disorders of the gastrointestinal tract.

It is a further object of the present invention to provide a method for assessing risk for developing GI cancer, including gastric cancer.

### SUMMARY

The invention is a high throughput approach to rapidly identify candidate biomarkers that are associated with one or more disorders of the gastrointestinal tract, including but not limited to, stomach diseases such as gastric cancer. The invention is also a method for assessing risk for developing disorders of the gastrointestinal tract, including, but not limited to, stomach diseases such as gastric cancer.

The method utilizes analysis of cellular samples (e.g., cells, tissues, organs) that include a chemically crosslinked analyte (e.g., formalin-fixed proteins), wherein the sample is embedded in an organic solid material (e.g., paraffin) involving the use of mass spectrometry.

More specifically, the present invention provides a method of analysis using mass spectrometry of chemically fixed, paraffin-embedded, tissues following reversal of at least a portion of the chemically crosslinked analytes (e.g., crosslinked proteins) to form decrosslinked analytes in a process commonly referred to as “antigen retrieval.”

Because mass spectrometry depends on the ionizability of a substance, and in the case of proteins, the ionizability of the proteins, it is possible to perform mass spectrometry on proteins since their primary structure is maintained and it is this primary structure that is analyzed using mass spectrometry (and associated methods). Because the methods such as mass spectrometry use known sequences of protein fragments to identify the proteins (e.g., peptide fingerprinting), mass spectrometry now can be successfully applied to articles derived from paraffin-embedded tissue samples.

Thus, the antigen retrieval step (decrosslinking) of the present invention unlocks a wealth of untapped proteomic information by enabling the analysis of previously chemically fixed paraffin-embedded tissue samples, including tissue microarrays (TMAs). In preferred embodiments, the use of mass spectrometric analysis techniques allow the simultaneous identification of multiple proteins.

Reversing the chemical crosslinks (i.e., breaking the bonds formed from chemically crosslinking the analyte or “decrosslinking”) can occur through a variety of techniques. For example, it can occur through the application of energy in the presence of water or buffer at a range of pH values. The energy applied can be heat or radiation. Preferably, the conditions are selected in the reversing step such that substantially no naturally occurring bonds in the analyte are broken.

In certain embodiments, the method can further include cleaving at least a portion of the naturally occurring bonds (or other bonds not formed by the chemical fixative) in the decrosslinked analyte to form analyte fragments. For proteins, typically the cleavage occurs with an enzyme, such as trypsin, or by chemical cleaving reagents, such as cyanogen bromide. This cleavage step can occur prior to or after decrosslinking, although it is preferred that this step be carried out after decrosslinking. Chemical and/or enzymatic cleavage results in fragments of the analyte, e.g., peptides from proteins that are amenable to analysis by methods dependent on their primary structure, such as mass spectrometry. Furthermore, although not preferred, the decrosslinking step could also result in fragmentation of the analytes in addition to decrosslinking. In certain embodiments, analyzing the decrosslinked analyte can include identifying and/or quantifying the decrosslinked analyte.

Embodiments of the invention also relate to methods for analyzing mass spectra. In some embodiments of the invention, a digital computer forms a classification model that can be used to differentiate classes of samples associated with different biological statuses. The classification model can be used as a diagnostic tool for prediction. It may also be used to identify potential markers associated with a biological status. In addition, the classification model can be formed using a process such as, for example, a recursive partitioning process.

One embodiment of the invention is directed to a method that analyzes mass spectra using a digital computer. The method comprises: entering into a digital computer a data set obtained from mass spectra from a plurality of the cellular samples, wherein each sample is, or is to be assigned to a class within a class set comprising two or more classes, each class characterized by a different biological status, and wherein each mass spectrum comprises data representing signal strength as a function of mass-to-charge ratio or a value derived from mass-to-charge ratio; and b) forming a classification model which discriminates between the classes in the class set, wherein forming comprises analyzing the data set by executing code that embodies a classification process comprising a recursive partitioning process.

Another embodiment of the invention is directed to a method for classifying an unknown sample into a class characterized by a biological status using a digital computer. The method comprises: a) entering data obtained from a mass spectrum of the unknown sample into a digital computer; and b) processing the mass spectrum data using a classification model to classify the unknown sample in a class characterized by a biological status. The classification model may be formed using a recursive partitioning process.

A variety of different types of cellular samples (e.g., tissue and/or individual cells) can be used, including microarrays. In the preferred embodiment where the specimen under analysis is a microarray, at least one sample is from a human. In another aspect, at least one sample is from an individual having a disease or disorder. In a further aspect, the disease is a progressive disease and the sample is a microarray that includes a plurality of samples representing different stages in the progression of the disease. In one aspect, the disease is cancer. In another aspect, the disease is an infectious disease, an immune disease, a disease affecting the endocrine system, a disease affecting the digestive system, and/or a neuropsychiatric disease. In the case of a chronic disease, the microarray can include samples representing both remission periods and exacerbation periods.

In one embodiment, cellular samples are obtained from sampling of the gastrointestinal (GI) system or tract. Such samples may include, but are not limited to, oral, esophageal, gastric, and intestinal cells. These samples are then analyzed by the methods described herein to identify biomarkers associated with disorders of the GI tract, for example, malignancies.

In one embodiment, cellular samples are obtained from individuals infected with Helicobacter pylori (H. pylori). These samples are then analyzed by the methods described herein to identify biomarkers associated with concurrent or subsequent development of other GI tract disorders, for example, stomach diseases such as gastric cancer.

Similar variation in types and disease status can be applied to samples from a variety of experimental animals, e.g., mouse or rabbit. Individual tissues or collections of tissues, as in tissue microarrays, can be analyzed in a manner identical to human tissue, reflecting the utility of the method in drug target identification and/or validation. Preferably, the non-human animal is an animal model for a disease. In another aspect, the non-human animal includes at least one cell having therein exogenous nucleic acid (i.e., a nucleic acid which is not naturally found in the genome of an animal or plant).

In a further aspect, the non-human animal has been treated with a therapy for treating the disease.

The following definitions are provided for specific terms that are used in the following written description.

The terms “comprises” and variations thereof do not have a limiting meaning where these terms appear in the description and claims.

As used herein, “a,” “an,” “the,” “at least one,” and “one or more” are used interchangeably. Thus, for example, a sample that comprises a chemically crosslinked analyte can be interpreted to mean that the sample includes “one or more” such analytes.

As used herein, “analyte” shall mean a molecule, compound, composition, or complex, either naturally occurring or synthesized, to be detected or measured in or separated from a sample of interest. Analytes include, without limitation, proteins, peptides, amino acids, fatty acids, nucleic acids, carbohydrates, hormones, steroids, lipids, vitamins, bacteria, viruses, pharmaceuticals, and metabolites. These analytes may or may not be capable of being crosslinked by a chemical fixative. For example, certain analytes, such as pharmaceuticals, metabolites, and vitamins, may not be chemically crosslinked, but can be analyzed in the method.

As used herein, “chemically crosslinked analyte” is an analyte that has been crosslinked using chemical means as a result of the addition of a chemical fixative capable of crosslinking, such as formalin or glutaraldehyde, for example. This does not include ethanol fixation. That is, although the analyte may have crosslinks within the molecule prior to addition of a chemical fixative, additional “chemical crosslinks” are incorporated into the analyte using a chemical crosslinking reagent (e.g., fixative).

As used herein, “a cellular sample” is one that is biological in nature in that it includes cells, whether they are individual cells, a part of a tissue, or a part of an organ. It is a recognized practice to isolate cells, e.g., from a biological fluid, form aggregates of the cells, e.g., by centrifugation, and to create chemically fixed paraffin embedded sections of the cell aggregates, commonly referred to as “cell blocks”. The cells within the cell block reflect their tissues and organs of origin.

As used herein, a “tissue” is an aggregate of cells that perform a particular function in an organism and generally refers to cells and cellular material (e.g., such as extracellular matrix material) from a particular physiological region. The cells in a particular tissue can include several different cell types. A non-limiting example of this would be brain tissue that further includes neurons and glial cells, as well as capillary endothelial cells and blood cells.

As used herein, “chemically fixed, paraffin-embedded tissue section” refers to a chemically fixed, paraffin-embedded, material, such as formalin-fixed paraffin-embedded tissue. This term is often used conventionally to refer to tissues, cells, or organs embedded in paraffin. Herein, this is also referred to as “chemically fixed, paraffin-embedded cellular sample.” While referred to as a “section,” the embedded tissue or cell(s) can be generally of any shape or size, and are generally 20 microns or less in thickness.

As used herein, “a tissue microarray” is a microarray that includes a plurality of microscopic locations, each location comprising tissue cells and/or extracellular materials from tissues, or cells typically infiltrating tissues, where the morphological features of the cells or extracellular materials at each location are visible through microscopic examination. The term “microarray” implies no upper limit on the size of the tissue sample on the microarray, but merely encompasses a plurality of cellular (e.g., tissue) samples that, in one aspect, can be viewed using a microscope. As used herein “different types of tissues” refers to tissues which are preferably from different organs or which are at least from anatomically and histologically distinct sites in the same organ.

The above summary of the present invention is not intended to describe each disclosed embodiment or every implementation of the present invention. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

### BRIEF DESCRIPTION OF THE DRAWINGS

FIG. 1 illustrates the tissue origin and biological status of various patient samples analyzed using the methods described herein.

FIG. 2 illustrates haematoxylin and eosin staining of two sections obtained from patient case 2 in Example 1.

FIGS. 3a and 3b illustrates haematoxylin and eosin staining of sections obtained from patient case 3 at 100× magnification in Example 1.

### DETAILED DESCRIPTION OF ILLUSTRATIVE EMBODIMENTS

The invention is directed to the analysis of cellular samples (e.g., cells, tissues, organs) that include a chemically crosslinked analyte (e.g., formalin-fixed proteins), wherein the sample is embedded in an organic solid material (e.g., paraffin) involving the use of mass spectrometry. The method can be used on tissue microarrays comprised of formalin-fixed paraffin embedded tissue with or without enzymatic degradation to distinguish various tumor types from one another. This represents a potentially useful approach to the growing field of “theranostics”—diagnosis or identification of proper therapy for a given disease.

The cellular sample is one that is biological in nature in that it includes cells, whether they are individual cells, a part of a tissue, or a part of an organ. The cellular sample preferably includes a tissue section. Preferably, the cellular sample includes formalin-fixed tissue.

Preferably, the cellular sample is a gastrointestinal cellular sample, including individual cells, a part of a tissue, or part of an organ from the GI system. The GI system is a long (approximately 30 foot) tube running through the body, with specialized sections that are capable of digesting material put in at the top end and extracting any useful components from it, then expelling the waste products at the bottom end. The digestive system is generally subdivided into the upper GI tract and the lower GI tract, with organs and accessory structures. GI organs include the esophagus, stomach, small intestine (including the duodenum, jejunum, ileum), large intestine (including the colon and rectum) and the anus. Accessory structures include the salivary glands, the pancreas, the liver and the gallbladder.

In a particular embodiment, the cellular sample is a stomach sample. It can be single cells or a part of any substructure of the stomach, such as the cardia, fundus, body or pylorus. In one embodiment, the cellular sample includes cells or tissue from more than one sub-structure of the stomach.

The cellular sample may be from any layer of the GI tract and may include one or more layers. Once past the oral cavity, most of the digestive tract has a distinct structural pattern that typifies tubular organs in general. Although there are variations from place to place, especially in the nature of the lining epithelium and/or the presence of some structures, generally it includes four “tunics” or layers, some of which have subdivisions. From the innermost (i.e., closest to the lumen) to the outermost, these are the tunica mucosa (the innermost layer, closest to the lumen, including the epithelium, lamina propria and the muscularis mucosae), the tunica submucosa (connective tissue supporting (outside, deep to) the mucosa), the tunica muscularis externa (muscular wall of the tract, surrounding (outside, deep to) the submucosa), and a tunica adventitia and/or tunica serosa.

In one embodiment, the cellular sample is mucosal epithelium from the GI tract. The mucosal epithelium lines the entire length of the GI tract. It is highly differentiated along the several regions of the GI tract. At the upper and lower ends of the tract, the epithelium is protective, stratified squamous. This protective epithelium is partially keratinized on the hard palate and gums and on the tips of filiform papillae of the tongue. Elsewhere in the oral cavity, esophagus, and anal canal the epithelium is non-keratinized. Along the lining of the stomach small intestine, and colon, the epithelium is simple columnar. Each region contains certain specialized cell types which are adapted to carry out the region's characteristic functions of secretion and absorption.

In a specific embodiment, the cellular sample is a sample from one or more layers of the stomach, such as the stomach mucosa, stomach submucosa, stomach muscularis externa, or stomach serosa.

In a particularly preferred embodiment, the invention provides a method of analyzing a chemically fixed, paraffin-embedded, tissue section using mass spectrometry. The tissue samples analyzed by the method of the present invention can be evaluated in high throughput parallel analyses using MALDI mass spectrometry, enabling gene identification, protein identification, molecular profiling, selection of promising drug targets, sorting and prioritizing of expressed sequence array data, and the identification of abnormal physiological processes associated with disease.

In a preferred embodiment, a cellular sample (e.g., tissue sample) that has been chemically crosslinked (e.g., fixed with formalin), embedded in an organic solid material (e.g., paraffins), formed either into a block or a microarray, both of which are then typically formed into 5-micron thick sections, can be subjected to a process that makes available an analyte by reversing at least a portion of the chemical crosslinks to form decrosslinked analyte, such as the process described in applicants' U.S. Pat. No. 8,012,693, entitled Analysis of Chemically Crosslinked Cellular Samples.

The process is preferably accomplished while substantially no naturally occurring bonds (or other bonds present prior to crosslinking) in the analyte are cleaved. If desired, the sample can be separated from the solid organic material (e.g., paraffin). This can occur prior to reversing the crosslinking. It can be accomplished by steam or any heating method. Preferably, this occurs at a temperature below that which causes decrosslinking.

A variety of techniques can be used to reverse at least a portion of the chemical crosslinks. Preferably, this is done through the application of energy. This can be accomplished in the presence of water or buffer at a range of pH values. The energy can be heat or radiant energy. Other methods can also be used including the use of chemical reagents, including acids such as citric acid. Such techniques are described in Shi S-R, Cote R J, Taylor C R., “Antigen retrieval immunohistochemistry: past, present, and future,” J Histochem Cytochem 1997; 45(3):327-343.

This decrosslinked analyte can be directly subjected to analysis by a method such as mass spectrometry. Alternatively, the decrosslinked analyte can be subjected to a process for cleaving at least a portion of the naturally occurring bonds (or other bonds present prior to crosslinking) within the analyte. This can be done chemically or enzymatically (e.g., using trypsin), for example.

Optionally, the decrosslinked and/or cleaved analyte can be treated or tagged with a molecular probe (e.g., a dye) that can assist in enhancing or suppressing signal intensity of the analyte in a controlled manner. Such reagents and methods are well-known to one of skill in the art. For example, tagging the phosphopeptides can occur through various well-known methods such as Immobilized Metal Affinity Chromatography (MAC). As used herein a “molecular probe” is any detectable molecule or molecule which produces a detectable signal upon reacting with a biological molecule. “Reacting” encompasses binding, labeling, or initiating an enzymatic reaction. Such detectable molecular probe can be recognized by a detectable binding reagent. In this context, a “detectable binding reagent” refers to an agent that specifically recognizes and interacts or binds with a molecular probe associated with an analyte one wishes to measure, wherein the agent has a property permitting detection when bound. “Specifically recognize and interact” means that a binding agent interacts with the molecular probe associated with the analyte one wishes to measure, to the substantial exclusion of other analytes also present in the sample. A detectable binding reagent can possess an intrinsic property that permits direct detection, or it can be labeled with a detectable moiety. As used herein, “detectable moiety” refers to a moiety that can be attached to a binding reagent that confers detection of the binding reagent by a particular method or methods. Detectable moieties include, but are not limited to, radiolabels (e.g., 32P, 35S, 125I, etc.), enzymes (e.g., alkaline phosphatase, peroxidase, etc.), fluorophores (e.g., fluorescein, amino coumarin acetic acid, tetramethylrhodamine isothiocyanate (TRITC), Texas Red, Cy3.0, Cy5.0, green fluorescent protein, etc.) and colloidal metal particles.

The method preferably includes cleaving at least a portion of other bonds (e.g., naturally occurring bonds or other bonds within the analyte prior to crosslinking) in the decrosslinked analyte to form analyte fragments. These analyte fragments can then be analyzed. Cleaving at least a portion of the bonds in the decrosslinked analyte includes contacting the decrosslinked analyte with an enzyme or chemical reagent. Preferably, an enzyme is used, such as trypsin, pepsin, pronase, chymotrypsin, and combinations thereof.

This cleavage step can occur prior to or after decrosslinking, although it is preferred that this step be carried out after decrosslinking. Chemical and/or enzymatic cleavage results in fragments of the analyte, e.g., peptides from proteins that are amenable to analysis by methods dependent on their primary structure, such as mass spectrometry. Furthermore, although not preferred, the decrosslinking step could also result in fragmentation of the analytes in addition to decrosslinking.

It should be understood that cellular samples can include analytes that are not crosslinked and subsequently decrosslinked. For example, certain analytes, such as pharmaceuticals, metabolites, and vitamins, may not be chemically crosslinked. Such analytes can also be analyzed along with the decrosslinked analytes using the methods of the present invention.

The digest can be directly subjected to a method of analysis, such as mass spectrometry, or an eluate of the digest can be removed and this can be subjected to a method of analysis. In a preferred embodiment, the method of analysis is mass spectrometry.

In embodiments of the invention, a data set obtained from mass spectra is entered into a digital computer to form a classification model by the method described in U.S. Pat. No. 6,675,104 which is incorporated herein by reference in its entirety. The mass spectra are preferably obtained from tissue samples having known characteristics. In preferred embodiments, the data set used to form the classification model is characterized as a “known” data set, because the biological statuses associated with the biological samples are known before the data set is used to form the classification model. In comparison, an “unknown” data set includes data that is obtained from mass spectra of samples where it is unclear if the samples are associated with the biological statuses which are discriminated by the classification model when the mass spectra are formed. Unknown data may be derived from a biological sample from a test patient who is to be diagnosed using the classification model. In some environments, the known data set is referred to as “training data”. In some embodiments of the invention, the data set used to form the classification model may be an unknown data set.

In embodiments of the invention, each cellular sample used is, or is to be assigned to a class of a set of two or more classes, and each class is characterized by a different biological status. For example, a first class of samples may be associated with a biological status such as a diseased state. A second class of mass spectra of samples may be associated with a biological status such as a non-diseased state. The samples in the first and second classes may form the class set. The mass spectra from each of the respective classes can contain data that differentiates the first and the second classes.

In embodiments of the invention, each mass spectrum in the analyzed mass spectra could comprise signal strength data as a function of time-of-flight, a value derived from time-of-flight (e.g. mass-to-charge ratio, molecular weight, etc.), mass-to-charge ratio, or a value derived from mass-to-charge ratio (e.g., molecular weight). As known by those of ordinary skill in the art, mass-to-charge ratio values obtained from a time-of-flight mass spectrometer are derived from time-of-flight values. Mass-to-charge ratios may be obtained in other ways. For example, instead of using a time-of-flight mass spectrometer to determine mass-to-charge ratios, mass spectrometers using quadrupole analyzers and magnetic mass analyzers can be used to determine mass-to-charge ratios.

In preferred embodiments, each mass spectrum comprises signal strength data as a function of mass-to-charge ratio. In a typical spectral view-type mass spectrum, the signal strength data may be in the form of “peaks” on a graph of signal intensity as a function of mass-to-charge ratio. Each peak may have a base and an apex, where peak width narrows from the base to the apex. The mass-to-charge ratio generally associated with the peak corresponds to the apex of the peak. The intensity of the peak is also generally associated with the apex of the peak.

Generally, the mass-to-charge ratio relates to the molecular weight of a potential marker. For example, if a potential marker has a charge of +1, then the mass-to-charge ratio is equal to the molecular weight of the potential marker represented by the signal. Thus, while some mass spectra plots may show signal intensity as a function of molecular weight, the molecular weight parameter is in fact derived from mass-to-charge ratios.

While many specific embodiments of the invention discussed herein refer to the use of mass-to-charge ratios, it is understood that time-of-flight values, or other values derived from time-of-flight values, may be used in place of mass-to-charge ratio values in any of the specifically discussed exemplary embodiments.

The data set may comprise any suitable data and may be entered automatically or manually into a digital computer. The data may be raw or preprocessed before being processed by the classification process run on the digital computer. For example, the raw intensities of signals at predetermined mass-to-charge ratios in the mass spectra may be used as the data set. Alternatively, the raw data may be preprocessed before the classification model is formed. For example, in some embodiments, the log values of the intensities (e.g., base 2) of the signals in the mass spectra may be used to form the data set.

The data set is entered into the digital computer. Computer code that embodies a classification process uses the data set to form a classification model. Exemplary classification processes include hierarchical classification processes such as a classification and regression tree process, multivariate statistical analyses such as a cluster analysis, and non-linear processes such as a neural network analysis. In preferred embodiments, the data set is processed using a classification and regression tree process to produce a classification model such as a classification and regression tree. These and other classification processes and classification models are described in greater detail below.

The created classification model may be predictive or descriptive. For example, the model can be used to predict whether an unknown test biological sample is or is not associated with a particular biological status. Alternatively or additionally, the classification model may be interrogated to identify features in the data that differentiate the biological status(s) being analyzed. A feature includes any aspect of the mass spectra data that can differentiate the particular classes being analyzed.

Suitable features that can be identified include, but are not limited to, signal intensities or signal intensity ranges at one or more mass-to-charge ratios, signal shapes (e.g., peak shapes), signal areas (e.g., peak areas), signal widths (e.g., peak widths such as at the bottom of a peak), the number of signals in each mass spectrum, etc. In a typical example, the classification model may indicate that a feature such as a particular signal intensity at a given mass-to-charge ratio differentiates diseased samples from non-diseased samples. In yet another example, the classification model may indicate that a combination of features differentiates diseased samples from non-diseased samples. For example, signal intensity ranges for two or more signals at different mass-to-charge ratios may differentiate a diseased state from a non-diseased state.

As used herein, “biological status” or “biological state” of a sample refers to any characterizing feature of a biological state of the sample or the organism or source from which the sample is derived. The feature can be a biological trait such as a genotypic trait or a phenotypic trait. The feature can be a physiological or disease trait, such as the presence or absence of a particular disease, including infectious disease. The feature also can be a condition (environmental, social, psychological, time-dependent, etc.) to which the sample has been exposed.

Genotypic traits can include the presence or absence of a particular gene or polymorphic form of a gene, or combination of genes. Genetic traits may be manifested as phenotypic traits or exist as susceptibilities to their manifestation, such as a susceptibility to a particular disease (e.g., a propensity for certain types of cancer or heart disease).

Phenotypic traits include, for example, appearance, physiological traits, physical traits, neurological conditions, psychiatric conditions, response traits, e.g., or response or lack of response to a particular drug. Phenotypic traits can include the presence of absence of so-called “normal” or “pathological” traits, including disease traits. Another status is the presence or absence of a particular disease. A status also can be the status of belonging to a particular person or group such as different individuals, different families, different age states, different species, and different tissue types.

In some embodiments, the biological statuses may be, for example, one or more of the following in any suitable combination: a diseased state, a normal status, a pathological status, a drug state, a non-drug state, a drug responder state, a non-drug responder state, and a benign state. A drug state may include a state where patient who has taken a drug, while a non-drug state may include a state where a patient has not taken a drug. A drug responder state is a state of a biological sample in response to the use of a drug. Specific examples of disease states include, e.g., cancer, heart disease, autoimmune disease, viral infection, Alzheimer's disease and diabetes. More specific cancer statuses include, e.g., prostate cancer, bladder cancer, breast cancer, colon cancer, and ovary cancer. Biological statuses May also include beginning states, intermediate states, and terminal states. For example, different biological statuses may include the beginning state, the intermediate state, and the terminal state of a disease such as cancer.

In certain embodiments, the biological status (or statuses) may be one or more of the following: a general disease or disorder of the GI tract (e.g., motility disorders), a disease or disorder of the upper digestive tract, a disease or disorder of the lower digestive tract, and more specifically, a disease or disorder of any of the following GI organs or structures: the mouth, the pharynx, the esophagus, the stomach, the small intestine (the duodenum, jejunum and ileum), the large intestine (the cecum, colon, rectum). In certain embodiments, the biological status may also be a disease or disorder of an accessory structure, such as a disease or disorder of the pancreas, gall bladder and bile ducts or a disease or disorder of the liver.

Non-limiting examples of diseases or disorders include: H. pylori infection, gastritis (stomach inflammation), peptic (gastric) ulcer, duodenal ulcer, non-cardia gastric cancer, cardia gastric cancer, MALT lymphoma, esophagitis, laryngopharyngeal reflux, Zenker's diverticulum, esophageal motility disorder, esophageal stricture, gastroesophageal reflux disease (GERD), Barrett's esophagus, enteritis, colitis, Crohn's disease, esophageal cancer, colorectal cancer, dyspepsia, pyloric stenosis, achlorhydria, gastroparesis, gastroptosis, portal hypertensive gastropathy, gastric antral vascular ectasia, gastric dumping syndrome, Crohn's Disease, Ménétrier disease, linitis plastica, stomach polyps, and/or any other disease of the gastrointestinal tract known to one of skill.

In one embodiment, the biological state is known prior to commencement of the methods described herein. In another embodiment, the biological state is identified after commencement of the methods described herein. In yet another embodiment, multiple biological states may be present with some known and some unknown prior to commencement of the methods described herein. As a non-limiting example of this embodiment, the H. pylori positive status of a sample may be known before the methods described herein are performed. An additional stomach-related condition may be present, but not yet detected, prior to commencement of the methods described herein. The method is then performed and resultant data may be stored. Upon later diagnosis of the additional stomach disease in that patient, his or her sample data may be re-analyzed using the diagnosis as a second biological state. In a further embodiment, the second biological state may not arise until after the method is first performed (i.e. was not present at the time the method commenced). Upon later diagnosis of the second biological state, the sample data may be re-analyzed using this second biological state.

In instances where the biological state includes H. pylori infection, the infection may have been previously determined by any method known to one of skill in the art including, but not limited to, blood antibody testing, stool antigen testing, carbon urea breath testing, analysis of stomach biopsy sample(s), rapid urease testing, histological examination, microbial culturing, urine ELISA testing, analysis of clinical symptoms, and/or molecular biological methods including PCR and gene sequencing. In alternate embodiments, the infection may be diagnosed after commencement of the methods described herein.

The biological status may also reflect a particular stage of the disease. For example, each of stages 0, I, II, III and IV typically assigned to gastric cancer may be given its own unique biological status from which to be classified in the classification model. A biological status may also be assigned according to how the patient providing the sample is treated for the cancer. For example, the biological status may be one of the following: treated with surgery (for example, gastrectomy), treated with chemotherapy (for example fluorouracil (5-FU) and/or leucovorin), treated with radiation (for example 45 Gy), or treated with a combination of one or more of the previous. In one embodiment, a data set obtained from mass spectra from a plurality of GI cellular samples, for example, gastric cellular samples, is first entered into a digital computer. Each sample is assigned to a class within a class set comprising two or more classes, each class characterized by a different biological status. For example, class set 1 may be H. pylori positive and class set 2 may be H. pylori negative and within each class set may be a class for gastric cancer positive and a class for gastric cancer negative. The mass spectral data comprises data representing signal strength as a function of mass-to-charge ratio or a value derived from mass-to-charge ratio. Data between classes in a class set and among different class sets may be compared to determine unique characteristics of any one particular class. These signatures may be used as-is or proteins underlying such unique characteristics may be identified. In either instance, the results may be used as biomarkers.

In one embodiment, the present invention is a method of discovery of biomarkers associated with GI disease. In a particular embodiment, samples from normal and diseased GI tissue may be obtained and subjected to the methods of the invention described herein. The tissue samples may be used fresh or may be first chemically fixed/crosslinked (for example, fixed with formalin) and embedded in an organic solid material (for example, paraffin). In instances where the samples are first chemically fixed and embedded in an organic solid material, the samples may be in the form of a block or tissue microarray. The samples may also be mounted on a microscope slide. The samples may be first separated from the solid organic material (for example, by use of low heat). At least a portion of the chemical crosslinks may then be reversed to form decrosslinked analyte (for example, by use of high heat). The decrosslinked samples may then be subjected to a method of analysis. In one embodiment, this method of analysis may be mass spectrometry. In a particular embodiment, this method of analysis may be MALDI mass spectrometry. The method of analysis may be used to identify biomarkers present in both the normal and diseased samples. The biomarkers identified in each group, normal and diseased, may be compared and differences between the two groups may be used to identify biomarkers uniquely associated with the diseased samples. Biomarkers specific to particular GI diseases may be identified by the methods described herein.

In one embodiment, the present invention is a method to diagnose or assist in the diagnosis of GI disease. In a particular embodiment, a sample from a patient presenting with a clinical symptom of a GI disease (for example, stomach pain, rectal bleeding, vomiting, loose stool) may be obtained and subjected to the methods of the invention described herein. The tissue sample may be used fresh or may be first chemically fixed/crosslinked (for example, fixed with formalin) and embedded in an organic solid material (for example, paraffin). In instances where the sample is first chemically fixed and embedded in an organic solid material, the sample may be in the form of a block or tissue microarray. The sample may also be mounted on a microscope slide. The sample may be first separated from the solid organic material (for example, by use of low heat). At least a portion of the chemical crosslinks may then be reversed to form decrosslinked analyte (for example, by use of high heat). The decrosslinked sample may then be subjected to a method of analysis. In one embodiment, this method of analysis may be mass spectrometry. In a particular embodiment, this method of analysis may be MALDI mass spectrometry. The method of analysis may be used to identify biomarkers present in the sample and these biomarkers may be compared to biomarkers known to be associated with particular types of GI disease. Similarities between biomarkers identified in the patient sample and those in the known GI disease samples can be used by one of skill to make or assist in the diagnosis of the patient.

In a particular embodiment, the patient may present with symptoms of a GI disease and have a known diagnosis of a GI disease as well. In this embodiment, the methods of the invention described herein may be used to identify additional related diseases that may also be present. For example, a patient presenting with stomach pain and a known diagnosis of severe gastritis may be screened for possible early stage gastric cancer using the biomarkers uncovered by the methods described herein. The biomarker data may be used alone or in conjunction with other clinical testing to provide a diagnosis of gastric cancer.

In one embodiment, the present invention is a method to provide a prognosis or assist in the prognosis of GI disease. In a particular embodiment, a tissue sample from a patient with a known GI disease may be obtained. The tissue sample may be used fresh or may be first chemically fixed/crosslinked (for example, fixed with formalin) and embedded in an organic solid material (for example, paraffin). In instances where the sample is first chemically fixed and embedded in an organic solid material, the sample may be in the form of a block or tissue microarray. The sample may also be mounted on a microscope slide. The sample may be first separated from the solid organic material (for example, by use of low heat). At least a portion of the chemical crosslinks may then be reversed to form decrosslinked analyte (for example, by use of high heat). The decrosslinked sample may then be subjected to a method of analysis. In one embodiment, this method of analysis may be mass spectrometry. In a particular embodiment, this method of analysis may be MALDI mass spectrometry. The method of analysis may be used to identify biomarkers present in the sample and these biomarkers may be compared to biomarkers known to be associated with particular stages of the patient's GI disease. Similarities between biomarkers identified in the patient sample and those from specific stages of the disease can be used by one of skill to make or assist in the prognosis of the patient.

In one embodiment, the present invention is a method to devise a treatment protocol or assist in devising a treatment protocol for GI disease. In a particular embodiment, a tissue sample from a patient with a known GI disease may be obtained. The tissue sample may be used fresh or may be first chemically fixed/crosslinked (for example, fixed with formalin) and embedded in an organic solid material (for example, paraffin). In instances where the sample is first chemically fixed and embedded in an organic solid material, the sample may be in the form of a block or tissue microarray. The sample may also be mounted on a microscope slide. The sample may be first separated from the solid organic material (for example, by use of low heat). At least a portion of the chemical crosslinks may then be reversed to form decrosslinked analyte (for example, by use of high heat). The decrosslinked sample may then be subjected to a method of analysis. In one embodiment, this method of analysis may be mass spectrometry. In a particular embodiment, this method of analysis may be MALDI mass spectrometry. The method of analysis may be used to identify biomarkers present in the sample and these biomarkers may be compared to biomarkers from samples known to be responsive to particular types of treatment (for example, particular drugs or drug combinations). Similarities between biomarkers identified in the patient sample and those from samples known to be responsive to a particular treatment can be used by one of skill to make or assist in the formulation of a treatment plan.

In a particular embodiment, additional information regarding the patient's known GI disease may be obtained using the methods described herein and this information may be used to determine the proper treatment protocol. For example, an H. pylori infection in a patient may have been previously diagnosed using known techniques (for example, via carbon urea breath testing or serum antibody testing). A cellular sample from the patient may be subjected to the methods described herein and evaluated for the presence of biomarkers associated with particularly virulent strains of the bacteria (using biomarkers previously uncovered using the methods described herein). If present, the patient may undergo a more aggressive treatment regimen to fully eradicate the bacteria in hopes of preventing serious damage to the infected tissue.

In one embodiment, the present invention is a method for assessing a patient's risk for developing a disease or disorder of the GI system. In a particular embodiment, a tissue sample from a patient with a risk factor for GI disease (for example, obesity, tobacco use, prior stomach surgery, family history of certain GI diseases) may be obtained. The tissue sample may be used fresh or may be first chemically fixed/crosslinked (for example, fixed with formalin) and embedded in an organic solid material (for example, paraffin). In instances where the sample is first chemically fixed and embedded in an organic solid material, the sample may be in the form of a block or tissue microarray. The sample may also be mounted on a microscope slide. The sample may be first separated from the solid organic material (for example, by use of low heat). At least a portion of the chemical crosslinks may then be reversed to form decrosslinked analyte (for example, by use of high heat). The decrosslinked sample may then be subjected to a method of analysis. In one embodiment, this method of analysis may be mass spectrometry. In a particular embodiment, this method of analysis may be MALDI mass spectrometry. The method of analysis may be used to identify biomarkers present in the sample and these biomarkers may be compared to biomarkers known to be correlated to particular GI diseases. Similarities between biomarkers identified in the patient sample and biomarkers correlated to one or more specific GI diseases can be used by one of skill to provide a risk assessment for developing particular GI diseases.

In a particular embodiment, the patient may already have a known GI disease and the methods described herein may be used to assess the risk for developing one or more additional related diseases. For example, a patient may have a known H. pylori infection, but have no further identified deleterious gastric phenotype. The methods described herein may be used to assess the risk of developing one or more conditions known to be correlated to H. pylori infection, for example, ulcer or gastric cancer. As another example, a patient may present with gastritis without the presence of H. pylori. Since gastritis alone may linked to an increased risk of gastric cancer, this risk may be assessed via screening for biomarkers associated with early stage gastric cancer that have been established using the methods described herein.

Other statuses may be associated with different environments to which different classes of samples are subjected. Illustrative environments include one or more conditions such as treatment by exposure to heat, electromagnetic radiation, exercise, diet, geographic location, etc. For example, a class of biological samples (e.g., all blood samples) may be from a group of patients who have been exposed to radiation and another class of biological samples may be from a group of patients who have not been exposed to radiation. The radiation source may be an intended radiation source such as an x-ray machine or may be an unintended radiation source such as a cellular phone. In another example, one group of persons may have been on a particular diet of food, while another group may have been on a different diet.

In other embodiments of the invention, the different biological statuses may correspond to samples that are associated with respectively different drugs or drug types. In an illustrative example, mass spectra of samples from persons who were treated with a drug of known effect are created. The mass spectra associated with the drug of known effect may represent drugs of the same type as the drug of known effect. For instance, the mass spectra associated with drugs of known effect may represent drugs with the same or similar characteristics, structure, or the same basic effect as the drug of known effect. Many different analgesic compounds, for example, may all provide pain relief to a person. The drug of known effect and drugs of the same or similar type might all regulate the same biochemical pathway in a person to produce the same effect on a person. Characteristics of the biological pathway (e.g., up- or down-regulated proteins) may be reflected in the mass spectra.

A classification model can be created using the mass spectra associated with the drug of known effect and mass spectra associated with different drugs, different drug types, or no drug at all. Once the classification model is created, a mass spectrum can then be created for a candidate sample associated with a candidate drug of unknown effect. Using the classification model, the mass spectrum associated with the candidate sample is classified. The classification model can determine if the candidate sample is associated with the drug of known effect or another drug of a different type. If, for example, the classification model classifies the candidate sample as being associated with the drug of known effect, then the candidate drug is likely to have the same effect on a person as the drug of known effect. Accordingly, embodiments of the invention can be used, among other things, to discover and/or characterize drugs.

In embodiments of the invention, a gas phase ion spectrometer mass may be used to create mass spectra. A “gas phase ion spectrometer” refers to an apparatus that measures a parameter that can be translated into mass-to-charge ratios of ions formed when a sample is ionized into the gas phase. This includes, e.g., mass spectrometers, ion mobility spectrometers, or total ion current measuring devices.

The mass spectrometer may use any suitable ionization technique. The ionization techniques may include for example, an electron ionization, fast atom/ion bombardment, matrix-assisted laser desorption/ionization (MALDI), surface enhanced laser desorption/ionization (SELDI), or electrospray ionization.

In some embodiments, an ion mobility spectrometer can be used to detect and characterize a marker. The principle of ion mobility spectrometry is based on the different mobility of ions. Specifically, ions of a sample produced by ionization move at different rates due to their difference in, e.g., mass, charge, or shape, through a tube under the influence of an electric field.

The ions (typically in the form of a current) are registered at a detector and the output of the detector can then be used to identify a marker or other substances in the sample. One advantage of ion mobility spectrometry is that it can be performed at atmospheric pressure.

In preferred embodiments, a laser desorption time-of-flight mass spectrometer is used to create the mass spectra. Laser desorption spectrometry is especially suitable for analyzing high molecular weight substances such as proteins. For example, the practical mass range for a MALDI can be up to 300,000 daltons or more. Moreover, laser desorption processes can be used to analyze complex mixtures and have high sensitivity. In addition, the likelihood of protein fragmentation is lower in a laser desorption process such as a MALDI than in many other mass spectrometry processes.

Thus, laser desorption processes can be used to accurately characterize and quantify high molecular weight substances such as proteins.

In a typical process for creating a mass spectrum, a probe with a marker is introduced into an inlet system of the mass spectrometer. The marker is then ionized. After the marker ions are generated, the generated ions are collected by an ion optic assembly, and then a mass analyzer disperses and analyzes the passing ions. The ions exiting the mass analyzer are detected by a detector. In a time-of-flight mass analyzer, ions are accelerated through a short high voltage field and drift into a high vacuum chamber. At the far end of the high vacuum chamber, the accelerated ions strike a sensitive detector surface at different times. Since the time-of-flight of the ions is a function of the mass-to-charge ratio of the ions, the elapsed time between ionization and impact can be used to identify the presence or absence of molecules of specific mass-to-charge ratio. The time of flight data may then be converted into mass-to-charge ratios to generate a spectrum showing the signal strength of the markers as a function of mass-to-charge ratio.

Mass spectra data generated by the desorption and detection of markers can be preprocessed using a digital computer after or before generating a mass spectra plot. Data analysis can include the steps of determining the signal strength (e.g., height of signals) of a detected marker and removing “outliers” (data deviating from a predetermined statistical distribution). For example, the observed signals can be normalized. Normalization is a process whereby the height of each signal relative to some reference is calculated. For example, a reference can be background noise generated by instrument and chemicals (e.g., an energy absorbing molecule) which is set as zero in the scale. Then, the signal strength detected for each marker or other substances can be displayed in the form of relative intensities in the scale desired (e.g., 100). Alternatively, a standard may be admitted with the sample so that a signal from the standard can be used as a reference to calculate relative intensities of the signals observed for each marker or other markers detected.

### Forming the Data Set

Once the mass spectra are obtained, a data set such as a known data set is formed. The data set comprises data that is obtained from the mass spectra of the class set of biological samples. The mass spectra data forming the data set can be raw, unprocessed data. For example, raw signal intensity values at identified mass values from the mass spectra may be used to form the data set. In another example, raw signal patterns from mass spectra may be used to form the data set.

In alternative embodiments, data may be preprocessed before it is used to form the classification model. The mass spectra may then be processed in any suitable manner before being used to form the classification model. For example, the signals in the mass spectra may be processed by taking the log values of the signal intensities, removing outliers, removing signals which are less likely to be associated with potential markers, removing signals which have low intensities, etc.

In some embodiments, the data set may comprise raw or preprocessed pattern data that relates to the particular pattern of each mass spectrum. For example, for a mass spectrum comprising many signal peaks, the pattern of the signal peaks may constitute a fingerprint for the biological sample used to create the mass spectrum. The classification process can classify the different spectra according to patterns or pattern segments that may be common to the spectra in the respectively different classes differentiated by the classification model. A computer program such as a neural network program, for example, can receive plural mass spectra of known samples associated with known biological statuses. The neural network can be trained with the mass spectra data so that it can differentiate between mass spectra patterns belonging to the respectively different classes. The trained neural network can then be used to classify a mass spectrum associated with an unknown sample based on the pattern in the mass spectrum.

In other embodiments, the data set comprises data relating to the intensities of the signals in the mass spectra. In these embodiments, some or all of the signals in each mass spectrum may be used to form the data set. For example, the intensities of less than all of the signals (e.g., peaks) in a spectra view type mass spectrum can be used to form the data set. In preferred embodiments, mass-to-charge ratios are identified, and the identified mass-to-charge ratios are used to select signals from the mass spectra. The intensities of these selected signals can be used to form the data set. By using data from less than all signals in each mass spectrum to form the data set, the number of data points that will be processed is reduced so that data processing occurs more rapidly. Data of signals that have a low likelihood of representing acceptable markers may be excluded from the data set.

Mass-to-charge ratios may be identified in any number of ways. For example, the mass-to-charge ratios may be identified by comparing the mass spectra of different classes having different biological statuses. The mass-to-charge ratios of signals that are likely to differentiate the classes may be selected. The comparison may be performed manually (e.g., by a visual comparison) or may be done automatically with a digital computer. For example, mass spectra associated with different classes of samples can be visually compared with each other to determine if the intensity of a signal at a mass-to-charge ratio in a mass spectrum from one sample class is significantly greater than or less than a signal at the same mass-to-charge ratio in a mass spectrum from a different sample class, thus indicating potential differential expression. Mass-to-charge ratios where these signal differences occur may be selected. Alternatively or additionally, certain predefined criteria may be provided to first select certain signals or signal clusters. The selected signal clusters may then be used to identify particular mass-to-charge ratios. For example, signals or signal clusters having a signal intensity or average signal intensity above or below a certain signal intensity threshold may be automatically selected. Mass-to-charge ratios associated with these selected signals or signal clusters may then be identified.

Once mass-to-charge ratios are identified, intensity values are determined for each signal at the identified mass values for all mass spectra. The intensity value for each of the signals is normalized from 0 to 100 to remove the effects of absolute magnitude. Then, the logarithm (e.g., base 2) is taken for each normalized signal intensity. Taking the logarithm of the signal intensities removes skew from the measurements.

The log normalized data set is then processed by a classification process that can be embodied by code that is executed by a digital computer. After the code is executed by the digital computer, the classification model is formed.

### Forming the Classification Model

A classification process embodied by code that is executed by a digital computer can process the data set. The code can be executed by the digital computer to create a classification model. The code may be stored on any suitable computer readable media. Examples of computer readable media include magnetic, electronic, or optical disks, tapes, sticks, chips, etc. The code may also be written in any suitable computer programming language including, C, C++, etc.

The digital computer may be a micro, mini or large frame computer using any standard or specialized operating system such as a WINDOWS based operating system. In other embodiments, the digital computer may simply be a one or more microprocessors. The digital computer may be physically separate from the mass spectrometer used to create the mass spectra. Alternatively, the digital computer may be coupled to or physically incorporated into the mass spectrometer. Mass spectra data can be transmitted from the mass spectrometer to the digital computer manually or automatically. For example, in one embodiment, a known data set may first be obtained from a plurality of mass spectra. The known data set may then be manually entered into a digital computer running code that embodies a classification process. In another embodiment, the generation and/or collection of mass spectra data, the preprocessing of the data, and the processing of the preprocessed data by a classification process may be performed using the same physical computational apparatus.

In embodiments of the invention, additional data may be used to from the classification model. The additional data may or may not relate to mass spectra. For instance, in some embodiments, pre-existing marker data may be used in addition to a known data set to form the classification model.

Any suitable classification process may be used in embodiments of the invention. For example, the classification process may be a hierarchical classification process such as a classification and regression tree process or a multivariate statistical analysis. A multivariate statistical analysis looks at patterns of relationships between several variables simultaneously. Examples of multivariate statistical analyses include well known processes such as discriminate function analysis and cluster analysis.

In embodiments of the invention, the classification process preferably includes a hierarchical, recursive partitioning process such as a classification and regression tree process. In embodiments of the invention, the classification and regression tree process is embodied by computer code that can be executed by a digital computer. Examples of exemplary classification and regression tree processes appropriate for use with the present invention include those described in U.S. Pat. No. 6,675,104 which is incorporated herein by reference in its entirety.

The classification model may be used to classify an unknown sample into a biological status. In this method the mass spectrum of a test sample can be compared to the classification model associated with a particular biological status to determine whether the sample can be properly classified with the biological status. A mass spectrum of the unknown biological sample can be obtained, and data obtained from a mass spectrum of the unknown sample can be entered into a digital computer. The entered data may be processed using a classification model. The classification model may then classify the unknown sample into a particular class. The class may have a particular biological status associated with it, and the person can be diagnosed as having that particular biological status.

This method has particular use for clinical applications. For example, in the process of drug discovery, one may wish to determine whether a candidate molecule produces the same physiological result as a particular drug or class of drugs (e.g., the class of seratonin re-uptake inhibitors) in a biological system. A classification model is first developed that discriminates biological systems based on exposure to the drug or class of drugs of interest (e.g., persons or test animals). Then, the biological system is exposed to the test molecule and a mass spectrum of a sample from the system is produced. This spectrum is then classified as belonging or not belonging to the classification of known drug or group of drugs against which it is being tested. If the candidate molecule is assigned to the class, this information is useful in determining whether to perform further research on the drug.

Other potential applications include a classification model that discriminates various toxic and non-toxic biological states; a classification model that discriminates between persons who are responders and non-responders to a particular drug; and/or a classification model that distinguishes person having a disease from those who do not have the disease. Thus, this method is useful for clinical diagnostics.

One embodiment is directed to analyzing cancer and in one further embodiment, the cancer is gastric cancer. Pathologists grade cancers according to their histologic appearance. Features of low-grade cancers include enlarged nuclei with a moderate increase in nuclear/cytoplasmic ratio, small number of mitoses, moderate cytologic heterogeneity, and retention of generally normal architecture. Features of high-grade cancers include enlarged, bizarre looking nuclei with a high nuclear/cytoplasmic ratio; increased number of mitoses, some of which may appear atypical; and little or no resemblance to normal architecture. It is useful to develop a classification model that distinguishes a biological sample coming from un-diseased, low-grade cancer, and high-grade cancer, since this diagnosis often dictates therapeutic decisions as well as can predict prognosis. The sample can be a solid tissue biopsy or a fine needle aspirate of the suspected lesion. In one embodiment, the sample is a gastric tissue biopsy. This gastric tissue may be obtained by any means known to one of skill in the art, including, but not limited to, via upper endoscopy. The sample may include not only gastric tissue, but also portions of tissue from nearby structures as well, for example, the small intestine or esophagus. However, in another embodiment, the samples can derive from more easily collected sources from the group of individuals being tested, such as urine, blood or another body fluid. This is particularly useful for cancers that secrete cells or proteins into these fluids, such as bladder cancer, prostate cancer and breast cancer. Upon establishment of the classification model for these states, the model can be used to classify a sample from a person subject to diagnostic testing. In another application, a classification model is developed that discriminates between classes of individuals having a particular physical or physiological trait that is not pathologic. Then, individuals unknown to have the trait can be classified by testing a sample from the individual and classifying a spectrum into the class having the trait, or outside the class having the trait.

The classification model can also be used to estimate the likelihood that an unknown sample is accurately classified as belonging to a class characterized by a biological status. For instance, in a classification and regression tree, the likelihood of potential misclassification can be determined. Illustratively, a classification and regression tree model that differentiates a diseased state from a non-diseased state classifies an unknown sample from a patient.

### Systems Including Computer Readable Media

Some embodiments of the invention are directed to systems including a computer readable medium. The computer readable medium may be used for storing instructions to be executed by the digital computer.

The mass spectrometer can be operably associated with a digital computer without being physically or electrically coupled to the digital computer. For example, data from the mass spectrometer could be obtained (as described above) and then the data may be manually or automatically entered into the digital computer using a human operator. In other embodiments, the mass spectrometer can automatically send data to the digital computer where it can be processed. For example, the mass spectrometer can produce raw data (e.g., time-of-flight data) from one or more biological samples. The data may then be sent to the digital computer where it may be pre-processed or processed. Instructions for processing the data may be obtained from the computer readable medium. After the data from the mass spectrometer is processed, an output may be produced and displayed on a display.

A computer readable medium may contain any suitable instructions for processing the data from the mass spectrometer. For example, the computer readable medium may include computer code for entering data obtained from a mass spectrum of an unknown biological sample into the digital computer. The data may then be processed using a classification model. The classification model may estimate the likelihood that the unknown sample is accurately classified into a class characterized by a biological status.

### Sample Preparation

In one aspect, the samples are tissue samples. Tissue samples can be obtained from chemically fixed, paraffin-embedded, tissue, and in particular, formalin-fixed, paraffin-embedded, tissue. A chemically-fixed, paraffin-embedded, tissue sample according to the invention typically includes one or more sections derived from tissue and/or cells. Preferably, each sample has at least one known biological characteristic (e.g., such as tissue type or cell type or patient source).

The tissue can be in the form of a tissue microarray, such as those described in Kononen et al., 1998, Nat. Med. 4: 844-7. Generation of microarrays can be partially or fully automated using tissue microarrayers, such as the ones described in WO99/44062, WO 99/44063, and U.S. Pat. No. 6,136,592.

Cells also can be obtained to provide one or more samples. Cells typically are formed into paraffin sections by centrifugation. Cells can be obtained from suspensions of cells from tissues (e.g., from a suspension of minced tissue cells, such as from a dissected tissue), from bodily fluids (e.g., blood, plasma, sera, and the like), from mucosal scrapings (e.g., such as from buccal scrapings or pap smears), and/or from other procedures such as bronchial ravages, amniocentesis procedures, and/or leukophoresis. In some aspects, cells are cultured first prior to being made part of the sample to expand a population of cells to be analyzed. Cells from continuously growing cell lines, from primary cell lines, and/or stem cells, also can be used.

In one aspect, a sample includes a plurality of tissues/cells from a single individual, i.e., the sample is microarray representing the “whole body” of an individual. Tissues can be selected from the group consisting of skin, neural tissue, cardiac tissue, liver tissue, stomach tissue, large intestine tissue, colon tissue, small intestine tissue, esophagus tissue, lung tissue, cardiac tissue, spleen tissue, pancreas tissue, kidney tissue, tissue from a reproductive organ(s) (male or female), adrenal tissue, and the like. Tissues from different anatomic or histological locations of a single organ can also be obtained, e.g., such as from the cerebellum, cerebrum, and medulla, where the organ is the brain. Some microarrays include samples representative of organ systems (i.e., comprising samples from multiple organs within an organ system), e.g., the respiratory system, urinary system, kidney system, cardiovascular system, digestive system, and reproductive system (male or female). In a preferred aspect, a whole body microarray additionally comprises a sample of cells from a bodily fluid of the patient (e.g., from a blood sample).

The microarray also can include a plurality of cells from individuals sharing a trait. For example, the trait shared can be gender, age, pathology, predisposition to a pathology, exposure to an infectious disease (e.g., HIV), kinship, death from the same disease, treatment with the same drug, exposure to chemotherapy, exposure to radiotherapy, exposure to hormone therapy, exposure to surgery, exposure to the same environmental condition (e.g., such as carcinogens, pollutants, asbestos, TCE, perchlorate, benzene, chloroform, nicotine and the like), the same genetic alteration or group of alterations, expression of the same gene or sets of genes (e.g., samples can be from individuals sharing a common haplotype, such as a particular set of HLA alleles), and the like.

Samples can be obtained from an individual with a disease or pathological condition, including, but not limited to: H. pylori infection, gastritis (stomach inflammation), peptic (gastric) ulcer, duodenal ulcer, non-cardia gastric cancer, cardia gastric cancer, MALT lymphoma, esophagitis, laryngopharyngeal reflux, Zenker's diverticulum, esophageal motility disorder, esophageal stricture, gastroesophageal reflux disease (GERD), Barrett's esophagus, enteritis, colitis, Crohn's disease, esophageal cancer, colorectal cancer, dyspepsia, pyloric stenosis, achlorhydria, gastroparesis, gastroptosis, portal hypertensive gastropathy, gastric antral vascular ectasia, gastric dumping syndrome, Crohn's Disease, Ménétrier disease, linitis plastica, stomach polyps, and/or any other disease of the gastrointestinal tract known to one of skill; diseases of the spleen, appendix, or gall bladder; a blood disorder; blood lipid disease; autoimmune disease; bone or joint disorder; a cardiovascular disorder; respiratory disease; endocrine disorder; immune disorder; infectious disease; muscle wasting and whole body wasting disorder; neurological disorders including neurodegenerative and/or neuropsychiatric diseases; skin disorder; kidney disease; scleroderma; stroke, hereditary hemorrhage telangiectasia; diabetes; disorders associated with diabetes (e.g., PVD); hypertension; Gaucher's disease; cystic fibrosis; sickle cell anemia; liver disease; pancreatic disease; eye, ear, nose and/or throat disease; diseases affecting the reproductive organs; and the like. Many of the prior noted diseases may be categorized as genetic diseases. For further discussion of human gene diseases, see Mendelian Inheritance in Man: A Catalog of Human Genes and Genetic Disorders by Victor A. McKusick (12th Edition (3 volume set) June 1998, Johns Hopkins University Press, ISBN: 0801857422). Preferably, samples from a normal demographically matched individual and/or from a non-disease tissue from a patient having the disease are arrayed on the same or a different microarray to provide controls. In one embodiment, a control group may include H. pylori infected patients that do not have any other known stomach disease (for example, but not limited to, gastric cancer) at the time the sample is processed using the methods described herein. In another embodiment, a control group may not have any known stomach disease, including H. pylori, at the time the sample is processed using the methods.

In a preferred aspect, a sample is provided in a microarray format that includes a plurality of cells, which represent different stages of a cell proliferative disorder, such as cancer. In this context, “a cell proliferative disorder” is a condition marked by any abnormal or aberrant increase in the number of cells of a given type or in a given tissue.

Cancer is often thought of as the prototypical cell proliferative disorder, yet disorders such as atherosclerosis, restenosis, psoriasis, inflammatory disorders, some autoimmune disorders (e.g., rheumatoid arthritis), are also caused by abnormal proliferation of cells, and are thus examples of cell proliferative disorders.

In one aspect, in addition to including samples, which comprise the primary target of the disease (e.g., such as tumor samples), the microarray includes samples representing metastases of a cancer to secondary tissues/cells. Preferably, the microarray also includes normal tissues from the same patient from whom the abnormally proliferating tissue was obtained. In some aspects, at least one microarray includes cells from a cell line of cancerous cells (either primary or continuous cell lines). Samples can be homogeneous, including a single cell type (e.g., as in a small format or ultrasmall format microarray), or can be heterogeneous, including at least one additional type of cell or cellular material in addition to abnormally proliferating cells (e.g., as in large format microarrays where samples are generally larger than 0.6 mm in diameter). For example, the sample can include abnormally proliferating cells and at least one of fibrous tissue, inflammatory tissue, necrotic cells, apoptotic cells, normal cells, and the like.

Although in a preferred aspect of the invention, the tissue and/or cell samples include human specimens, in one aspect of the invention, specimens from other organisms are used. In one aspect, tissues from non-human animals are used that provide a model of a disease or other pathological condition. When the sample represents specimens from an animal model of a chronic disease, the sample can be in the form of a microarray which includes specimens representing different stages of the disease, e.g., such as from animals in a remission period or an exacerbation period. The microarray can additionally, or alternatively, include tissues from a non-human animal having the disease or condition that has been exposed to a therapy for treating the disease or condition (e.g., drugs, antibodies, protein therapies, gene therapies, antisense therapies, combinations thereof, and the like). In some aspects, the non-human animals can include at least one cell containing an exogenous nucleic acid (e.g., the animals can be transgenic animals, chimeric animals, knockout or knock-in animals). Preferably, arrays from non-human animals include multiple tissues/cell types from such a non-human animal. In one aspect, tissues/cells at different stages of development are used. In another aspect, samples from plants may be used, such as those discussed in Schumacher U., “Immunohistochemical assessment of cell proliferation in plant tissues using formaldehyde-fixed paraffin-embedded material,” Acta Histochem. 1995 July:97(3):291-4. Samples may include microarrays that include plants in different stages of their life cycle and/or different types of plant tissues. In some aspects, the plant samples can include at least one cell containing an exogenous nucleic acid (e.g., the plants can be transgenic plants).

In one embodiment, a section of formalin-fixed, paraffin embedded, tissue is obtained and stained with H&E. The stained section is used as a guide to select a region on the tissue section for sampling. While in some aspects, staining with a standard tissue or cell stain such as H&E can be suitable to identify cells or tissue areas of interest, in other aspects, sections of the tissue are evaluated for the expression of one or more biological characteristics (e.g., such as the expression of a genotype, transcript, or peptide, polypeptide, or protein of interest) in the sample represented by the section. An area of interest can be identified which expresses or does not express a particular biological characteristic.

In one embodiment, the sample is prepared by slicing a section of the tissue sample (i.e., cutting transversely from the tissue sample with respect to the longitudinal axis of the sample) and allowed to fall onto a substrate without crumpling. Preferably, each tissue sample generates 150 to 300 sections from 2 to 20 microns thick. More preferably, sections are 4 to 12 microns in thickness.

In some embodiments, an adhesive film is placed on a surface of the tissue sample both to keep the section flat after it is sliced and to provide a surface on which to more easily move the section to a substrate without tearing or wrinkling the section.

The section on its adhesive backing is then transferred to a substrate section side-down, and the adhesive film is peeled away from the section. Adhesive films and adhesive-coated slides are both obtainable from Instrumedics, Inc., Hackensack, N.J. (see, e.g., CRYOJAN Tape Transfer System).

It is preferred that the tissue sample be introduced to the substrate in a known pattern for purposes of registration. The initial starting position of the sample, for example, should be known in order to correlate this position with the final position once the substrate size has been reduced to the dimension that will be employed in conducting the assay. Examples include labeling, use of dyes, etc.

Once placed on a substrate, the tissue sample is processed by reversing at least a portion of the chemical crosslinks (i.e., those crosslinks formed by a chemical crosslinking agent such as formalin. This is known conventionally as an antigen retrieval step. Such a process is described in Shi S-R, Cote R J, Taylor C R., “Antigen retrieval immunohistochemistry: past, present, and future,” J Histochem Cytochem 1997; 45(3):327-343. During this decrosslinking step, the chemical fixation is reversed typically through the application of heat in the presence of water. For example, during decrosslinking of formalin-fixed, paraffin embedded, tissue, the tissue sample is subjected to 100° C. steam in the presence of citric acid at 9.3 pH. As known by those skilled in the art, modification of the acid used, the temperature and/or the pH will result in varying degrees of reversal of the crosslinking and antigen retrieval. Other energy sources include radiation energy, such as microwave energy.

The tissue section may be subject to a process of crosslink reversal (conventionally referred to as antigen retrieval) either before or after affixation to a substrate. In preferred embodiments, the tissue section is affixed to a substrate such as a glass slide before the reversal of crosslinks (decrosslinking).

In a preferred embodiment, the decrosslinked analyte can then be treated with an enzyme or chemical reagent to cleave at least a portion of the naturally occurring bonds or bonds present before crosslinking in the analyte of interest, such as proteins or peptides. Preferably, this involves in situ digestion. Suitable enzymes for cleaving the analyte include, but are not limited to, trypsin, chymotrypsin, pronase, and pepsin. In one embodiment with formalin-fixed, paraffin-embedded, tissue, the enzyme is trypsin. Other agents for cleaving the bonds may also be employed, such as formic acid and cyanogen bromide. Such agents and techniques are well-known to one of skill in the art.

In some embodiments, the methods described herein allow for preservation of the majority of the sample. This may be accomplished by any means known to one of skill in the art, for example, in utilization of reduced heat or chemical treatment or via treatment of only a portion of the sample. In some embodiments, portions of the original tissue sample taken from the patient may be preserved. In some embodiments, samples that undergo antigen retrieval, mass spectrometry, or both may be preserved and used for further testing. In certain embodiments, between about 50% to about 99% of the sample is preserved. Between about 50% to about 60%, between about 60% to about 70%, between about 70% to about 80%, between about 80% to about 90%, and/or between about 90% to about 99% of the sample may be preserved using the methods described herein.

In some embodiments, the methods described herein may be performed in situ and without the need for dissolution of the specimen. In certain embodiments, the sample is treated (for example, decrosslinked) while on the substrate. Treatment of the sample may be via any means known to be relevant to one of skill in the art including, but not limited to, treatment with heat, steam, chemicals, enzymes (for example, trypsin) and/or alteration of pH. Treatment may result in one or more of the following, removal of paraffin or other organic solid material, reversal of chemical crosslinks (wherein such crosslinks were formed by, for example, fixation with formalin) to form decrosslinked analyte, and/or cleavage of at least a portion of the naturally occurring bonds (or other bonds present prior to crosslinking) within the analyte. In certain embodiments, the sample is treated (for example, decrosslinked) and subjected to the method of analysis (for example, mass spectrometry) while on the same substrate. The substrate may be any of those known to one of skill in the art including, but not limited to, a glass microscope slide, a portion of a glass microscope slide, and/or a cover slip. In some embodiments, the sample is treated (for example, decrosslinked) on a glass microscope slide and the glass microscope slide is then placed on a plate for use in mass spectrometry. In some embodiments, the sample is treated (for example, decrosslinked) on a glass microscope slide and a portion of the glass microscope slide containing a desired section of the sample is then placed on a plate for use in mass spectrometry. In some embodiments, the sample is treated (for example, decrosslinked) on a glass microscope slide with a cover slip and the cover slip is then placed on a plate for use in mass spectrometry.

In some embodiments, the methods described herein may be performed on a glass slide containing a standard microscopic section. Both sample treatment (for example, decrosslinking) and analysis (for example, mass spectrometry) may be performed on a glass slide containing a standard microscopic section. The glass slide may be a conductive glass slide for use in mass spectrometry. In particular embodiments, no additional mass spectrometry plate is necessary and the conductive glass slide is used for both sample treatment and mass spectrometry.

### Methods of Use

In one aspect, samples analyzed according to the invention are used to assay the expression and/or form of a cancer-specific marker or tumor-specific antigen. As used herein, “a cancer-specific marker” or a “tumor-specific antigen” is an analyte that is expressed preferentially on cancer cells and tumor cells, respectively, and is not expressed or is expressed to small degree in non-cancer/tumor cells of an adult individual. In one embodiment, the cancer is a GI cancer, for example, gastric cancer.

In this context, “difference in expression characteristics” or a gene which is “differentially expressed” refers to an increase or decrease in a measurable expression characteristic of a given polypeptide. A difference can be an increase or a decrease in a quantitative measure (e.g., amount of protein or RNA encoding the protein) or a change in a qualitative measure (e.g., location of the protein).

A cancer-specific marker is any analyte that is involved in or correlates with the pathogenesis of a cancer, and can act in a positive or negative manner, as long some aspect of its expression or form influences or correlates with the presence or progression of cancer. While in one aspect, expressed levels of an analyte provide an indication of cancer progression or recurrence, in another aspect of the invention, the expressed form of an analyte provides the indication (e.g., a cleaved or uncleaved state, a phosphorylated or unphosphorylated state).

The cancer-specific marker can be the product of a characterized gene, e.g., such as a cell growth-related polypeptide, which promotes cell proliferation, or can be uncharacterized or only partially characterized (e.g., identified through the use of molecular profiling methods described above). Non-limiting examples of cancer-specific markers include growth factors, growth factor receptors, signal transduction pathway participants, and transcription factors involved in activating genes necessary for cell proliferation. Non-limiting examples of biomarkers associated with gastric cancer include homB and Cag-A. The so-called tumor antigens are also included among the growth-related polypeptides. Tumor antigens are a class of protein markers that tend to be expressed to a greater extent by transformed tumor cells than by non-transformed cells. As such, tumor antigens can be expressed by non-tumor cells, although usually at lower concentrations or during an earlier developmental stage of a tissue or organism. Tumor antigens include, but are not limited to, prostate specific antigen (PSA; Osterling, 1991, J. Urol. 145: 907-923), epithelial membrane antigen (multiple epithelial carcinomas; Pinkus et al. 5 1986, Am. J. Clin. Pathol. 85: 269-277), CYFRA 21-1 (lung cancer; Lai et al., 1999, Jpn. J. Clin. Oncol. 29: 421-421) and Ep-CAM (pan-carcinoma; Chaubal et al., 1999, Anticancer Res. 19: 2237-2242). Additional examples of tumor antigens include CA 125 (ovarian cancer), intact monoclonal immunoglobulin or light chain fragments (myeloma), and the beta subunit of human chorionic gonadotropin (HCG, germ cell tumors).

In further aspects of the invention, cancer progression can be detected and/or monitored by examining the expression of the activity of a cancer-specific marker. For example, in one aspect, the activity of telomerase is monitored in situ in samples. Methods of in situ detection of telomerase activity are known in the art and are described, for example, in U.S. Pat. No. 6,194,206.

The tissue samples can also be used in conjunction with, or to validate, results obtained through other types of the analyses with the same or other types of samples. For example, the methods of the present invention can be used in conjunction with, or instead of, analyses using in situ detection and visualization using immunohistochemistry; laser capture microdissection (LCM) of samples such as that described in PCT International Application Nos. WO 09917094A2 and WO 098352A1; gel electrophoresis and others, all of which are described in PCT International Application No. WO 02/48674 A2.

Tissue samples prepared according to the present invention also can be used to identify drug targets whose interactions with one or a plurality of analytes are associated with disease. For example, a drug target can be a molecule that is overexpressed or underexpressed during a pathological process. By identifying drug targets, drugs can be screened for which can restore a cell's/tissue's normal physiological functioning. For example, where a drug target is a molecule, which is overexpressed or underexpressed, a suitable drug could be a molecule (e.g., a therapeutic antibody, polypeptide, or nucleic acid), which restores substantially normal levels of the drug target.

In one aspect, identifying diagnostic analytes is performed by determining which molecules on a microarray are substantially always present in a disease sample and substantially always absent in a healthy sample, or substantially always absent in a disease sample and subkantially always present in a healthy sample, or substantially always present in a certain form or amount in a disease sample and substantially always present in a certain other form or amount in a healthy sample. By “substantially always” it is meant that there is a statistically significant correlation between the expression/form of the analyte or set of analytes and the presence of an aberrant physiological process, such as a disease.

Preferably, expression of a diagnostic analytes or set of analytes is examined in a microarray comprising tissues from a drug-treated patient and tissues from an untreated diseased patient and/or from a healthy patient. In this aspect, the efficacy of the drug is monitored by determining whether the expression profile of the diagnostic molecule(s) returns to a profile which is substantially similar (e.g., not significantly different as determined by routine statistical testing) to the expression profile of the same analyte(s) in a healthy patient or a patient who has achieved a desired therapeutic outcome. In one aspect of the invention, data relating to any, or all of, tissue type, stage of development or disease, patient history, family history, diagnosis, prognosis, medication, morphology, concurrent illnesses, expression of molecular characteristics (e.g., markers), and the like, are recorded and stored in a database, indexed according to the tissue sample obtained.

The methods described herein may also be used to determine the localization of proteins within a particular tissue section. For example, in gastric tissue samples, proteins associated with gastric cancer may be localized to a particular region of the tissue section. In performing the methods described herein, one of skill may not only identify such proteins, but also ascertain the geographic location of the proteins within the sample itself. Such localization may be assessed within a single cell or among multiple cells in a tissue section.

### EXAMPLES

These examples are merely for illustrative purposes only and are not meant to be limiting on the scope of the appended claims. All parts, percentages, ratios, etc. in the examples and the rest of the specification are by weight, unless noted otherwise. Furthermore, molecular weights in the examples and the rest of the specification are weight average molecular weights, unless noted otherwise.

### Example 1

### Gastric Adenocarcinoma Formalin-Fixed Paraffin Embedded Mass Spectrometry

### Identification of Biomarkers and Use Therein

### A. Antigen Retrieval Method

1. Antigen retrieval is carried out using Target Retrieval Solution (product code S 1699) available from DakoCytomation, Denmark. It is a modified citrate buffer, with a pH of 6.1 (modified with an unspecified amount of EDTA).

2. The procedure consists of taking 5μ tissue sections that have been previously formalin fixed and paraffin embedded and placed on charged (poly-L-lysine coated) slides to enhance adhesion.

3. The slides are heated to 60 degrees for 30-45 minutes. The sections are deparaffinized completely and rehydrated to deionized water by the following sequence.
a. Prior to beginning the deparaffmization steps, begin to preheat the target retrieval solution in the Black & Decker Vegetable Steamer. Fill the base of the steamer with deionized water to the high fill line. Place the drip tray in the base and place a covered coplin jar of retrieval solution into the tray. Set the steamer timer for 75 minutes (which should result in a solution temperature of 95-99 deg C.).
b. The level of solution is provided to cover the tissues. Begin the next steps once the steamer timer has ˜30 minutes remaining on the clock:
   i. Place warmed slides into xylene for 5 minutes. Repeat once,
   ii. Move slides to absolute ethanol for 3 minutes. Repeat once.
   iii. Move slides to 95% ethanol for 3 minutes. Repeat once,
   iv. Move slides to 70% ethanol for 3 minutes. Repeat once.
   v. Move to deionized water for 1 minute prior to placing slides into the preheated Target Retrieval Solution. The Target Retrieval Solution is purchased as a 10× concentrate that is diluted with deionized water prior to use. The coplin lid needs to be removed at this point for the lid to fit on the steamer,
   vi. The slides need to be immersed in the hot Target Retrieval Solution for 20 minutes.
   vii. Carefully remove the coplin jar from the steamer and place into the sink in order to run cold tap water around the coplin jar. Cool the slides with this running tap water for 20 minutes. Pour off the retrieval solution and rinse well with several changes of deionized water,
   viii. Place the slides into a room temperature wash buffer for 5 minutes prior to working with slides. (The buffer used currently is a Tris buffered saline solution containing Tween 20, pH7.6, available from DakoCytomation as a 10× concentrate. After dilution 1:10 with deionized water, the solution contains 50 mM Tris-HCl, 150 mM NaCl, 0.05% Tween 20 plus a preservative. The diluted wash buffer is stable for one week.)
   ix. The slides are now ready for analysis.
      B. Mass Spectrometry on Slides after Antigen Retrieval

Because the slides are too large for the MALDI device, the slides are hand cut to allow placement into a custom MALDI plate with a milled out recessed area. The histological slides are spotted with a trypsin solution and digested for 4.5 hours. After trypsin digestion the remaining surface liquid as well as the histological site of application is analyzed by MALDI-TOF. Additionally, a site is analyzed using MALDI without trypsinization.

### Procedure:

A positive control digest is performed using horse Cytochrome C. A 2.0 μg aliquot of trypsin is added to a sample containing 10.0 μg of Cytochrome C dissolved in Ammonium Bi-Carbonate (ABC) buffer. This sample is digested for 4.5 hours at 37° C. A trypsin digest blank is also performed as a negative control. A 2.0 μg aliquot of trypsin is mixed with 100 μl of ABC buffer and digested in the same manner.

### Trypsin Tissue Digest Step

1) Prepare Stock 0.5 μg/μl trypsin with 100 mM NH4HCO3 pH 8.1 (ABC).

2) Add ˜1.5 ug trypsin per specified spot and digest for 4.5 hours at 37° C.

(Add 5 μl of additional ABC buffer every 20 minutes due to drying. At 1 hour samples are moved into a heated humidified chamber to alleviate the drying issue. The samples remain moist for the remainder of the digest time.)

3) Pipette off the surface liquid from each spot and subsequently spot onto the MALDI plate. Each tissue location is rinsed with 3 μl of milli-Q H20 which is subsequently spotted onto the correlating MALDI plate well.

4) Add 0.25 ul of alpha CHCA matrix to each tissue spot and to each sample on the MALDI plate.

5) Optimize MALDI settings using the pos/neg control digests and the “test” digest spot.

6) Analyze the MALDI plate samples using reflectron mode. Also verify the sensitivity by analyzing with linear mode.

7) Continue to analyze the ON-tissue sample locations using linear mode and the MALDI plate samples using the Reflectron mode.

The prepared peptides are fingerprinted by using matrix assisted laser desorption ionization time-of-flight mass spectrometry (MALDI-TOF MS). Analyses are performed using a Voyager DE-STR (Applied Biosystems, Framingham, Mass.) in reflector and linear modes with positive ionization and an accelerating potential of either 20 or 25 kV. The instrument is calibrated with peptide and protein standards from Sequazyme Kit (Applied Biosystems) for mass accuracy. The nitrogen laser has a wavelength of 337 ηm, and the instrument is set to acquire 150 spectra per sample spot. The laser beam has a linear spot diameter of approximately 150-200 μm.

The data are then indexed using a dummy variable. The entire dataset is sequenced using the index variable as a sorting parameter, resulting in a sequence of data that are now spaced by 2 daltons between each reading. This “reduced” dataset, is used for subsequent analysis.

The data are normalized to the maximum and all measurements are converted to a fraction between 0 and 1 by dividing each value by the maximum of a given column. The normalized reduced data are then graphed to illustrate the relationship between relative intensities of observed peaks as a function of m/z ratio.

Normalized residuals are generated to illustrate both the shared and the unique signals from the samples. While the normalized residuals can distinguish between samples, it is not possible to identify the proteins using this method since peptide identification databases require digestion (most commonly with trypsin) and these results are obtained without modification. They are limited, therefore, to biomarkers without identification. Trypsin treatment, followed by repeat analysis can allow for identification, if peaks observed before treatment are lost after treatment with trypsin, indicating that the protein of interest can now be identified using peptide databases. Comparative experiments to histological samples may then be performed.

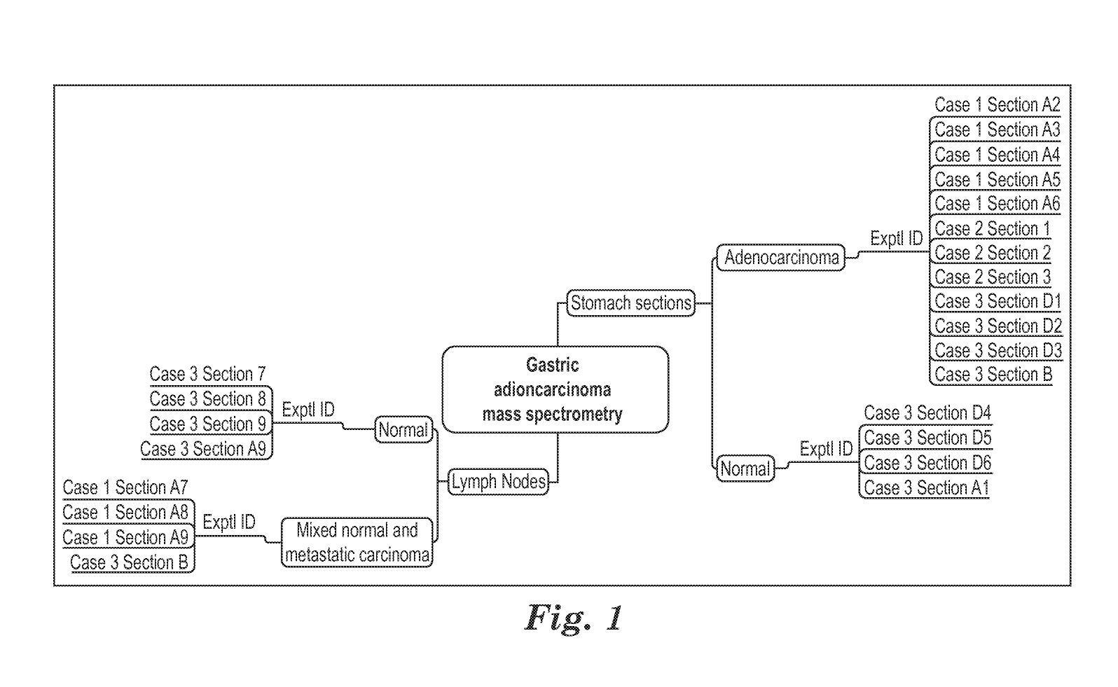

In the present example, tissue sources came from standard cases of gastric adeoncarcinoma diagnosed independently prior to analysis with mass spectrometry. Multiple sections from patients were received, de-identified and labeled only by “case” number and section. FIG. 1 illustrates the tissue origin and biological status (malignant, normal, mixed) of various patient samples analyzed. Each patient was identified by a unique case number and various sections from each patient were obtained and uniquely labeled. All sections were formalin fixed and paraffin embedded. Standard haematoxylin and eosin (H&E) staining was used. Mass spectrometry methods as described herein were performed on the tissues. As described, tissues were subjected to antigen retrieval (or reversal of formalin fixation) after which matrix associated laser desorption and ionization was carried out. Data consisted of mass to charge ratio (m/z) values that led to clearly demonstrable peaks. The data, retrieved as m/z peaks, were used to identify potential proteins using the MASCOT system and publicly available databases. Results from representative sections from those listed in FIG. 1 are presented in this example.

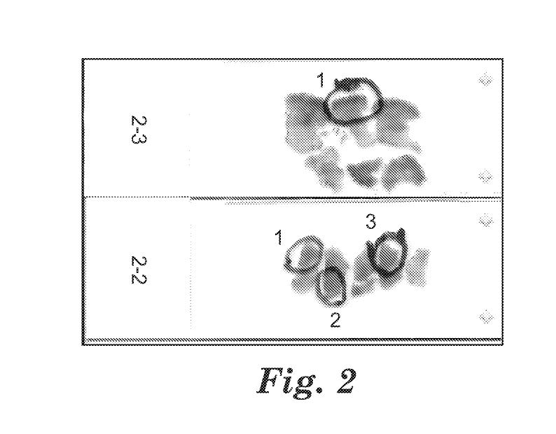

FIG. 2 illustrates haematoxylin and eosin (H&E) staining of two sections obtained from case 2, sections 2 (“2-2” on the slide in the figure) and 3 (“2-3”). Both sections are positive for gastric adenocarcinoma. “Spots” are circled and numbered in the figure and indicate the sites where laser was used. Table 1 represents proteins identified from case 2, sections 2 and 3 using data obtained from these spots. The case number is listed in the far left column and is followed by section, spot and protein identified. Unstained sections from the same slides were used to obtain the m/z peaks.

TABLE 1
Proteins identified in case 2, sections 2 and 3

| Case | Section | Spot | |
|---|---|---|---|
| 2 | 2 | 1 | ankyrin repeat and SOCS box-containing protein 2 [Homo sapiens] |
| 2 | 2 | 1 | c-has/bas p21 protein [Homo sapiens] |
| 2 | 2 | 1 | folylpolyglutamate synthetase mitochondrial isoform [Homo sapiens] |
| 2 | 2 | 1 | HLA-DQB1*0501 beta chain = MHC Class II antigen |
| 2 | 2 | 1 | mast cell carboxypeptidase A3 precursor [Homo sapiens] |
| 2 | 2 | 1 | MHC class II antigen [Homo sapiens] |
| 2 | 2 | 1 | Mitochondrial ribosomal protein S10 [Homo sapiens] |
| 2 | 2 | 1 | PTK2 protein tyrosine kinase 2 [Rattus norvegicus] |
| 2 | 2 | 1 | Ras-related protein Rab-25 |
| 2 | 2 | 1 | suppressor of cytokine signaling 3 [Homo sapiens] |
| 2 | 2 | 2 | aldo-ketoreductase [Homo sapiens] |
| 2 | 2 | 2 | Alpha-methylacyl-CoA racemase [Homo sapiens] |
| 2 | 2 | 2 | Granzyme C precursor (Cytotoxic cell protease 2) (CCP2) (B10) |
| 2 | 2 | 2 | neurexin 2 isoform alpha-2 precursor [Homo sapiens] |
| 2 | 2 | 2 | PREDICTED: ADP-ribosylation factor guanine nucleotide-exchange factor 2 |
| 2 | 2 | 2 | programmed cell death 4 isoform 1 [Homo sapiens] |
| 2 | 2 | 3 | CCT2 [Homo sapiens] |
| 2 | 2 | 3 | Chain B, Human Argininosuccinate Lyase |
| 2 | 2 | 3 | chaperonin containing TCP1, subunit 2 (beta) [Homo sapiens] |
| 2 | 2 | 3 | DHX8 protein [Homo sapiens] |
| 2 | 2 | 3 | Glycolipid transfer protein [Mus musculus] |
| 2 | 2 | 3 | interleukin 15 receptor, alpha [Homo sapiens] |
| 2 | 2 | 3 | kynurenine 3-monooxygenase [Rattus norvegicus] |
| 2 | 2 | 3 | latent transforming growth factor beta binding protein 4 isoform a [Homo sapiens] |
| 2 | 2 | 3 | mannose-binding lectin [Homo sapiens] |
| 2 | 2 | 3 | mitochondrial acyl-CoA thioesterase 1 [Mus musculus] |
| 2 | 2 | 3 | myosin IIIA [Homo sapiens] |
| 2 | 2 | 3 | phosphodiesterase 2A, cGMP-stimulated [Homo sapiens] |
| 2 | 2 | 3 | RAB3B, member RAS oncogene family [Homo sapiens] |
| 2 | 2 | 3 | Ras family small GTP binding protein RALA [Homo sapiens] |
| 2 | 2 | 3 | RPH3A protein [Homo sapiens] |
| 2 | 2 | 3 | synaptojanin [Homo sapiens] |
| 2 | 3 | 1 | 5′-3′ exoribonuclease 2 isoform 3 [Homo sapiens] |
| 2 | 3 | 1 | Melanoma cell adhesion molecule variant [Homo sapiens] |
| 2 | 3 | 1 | mitochondrial ribosomal protein S6 [Homo sapiens] |
| 2 | 3 | 1 | MSTP063 [Homo sapiens] |
| 2 | 3 | 1 | PREDICTED: similar to leucine-rich repeat kinase 2, partial [Bos taurus] |
| 2 | 3 | 1 | SLIT-ROBO Rho GTPase activating protein 3 isoform a [Homo sapiens] |
| 2 | 2 | 1 | T-cell receptor alpha [Homo sapiens] |
| 2 | 2 | 3 | transmembrane protease, serine 4 isoform 1 [Homo sapiens] |
| 2 | 2 | 3 | type II membrane serine protease [Homo sapiens] |
| 2 | 2 | 2 | UDP-glucose:glycoprotein glucosyltransferase 2 [Homo sapiens] |
| 2 | 2 | 2 | zinc finger protein 480 [Homo sapiens] |
| 2 | 2 | 3 | zinc regulatory factor [Homo sapiens] |
| 2 | 3 | 1 | zinc finger protein 291 [Homo sapiens] |

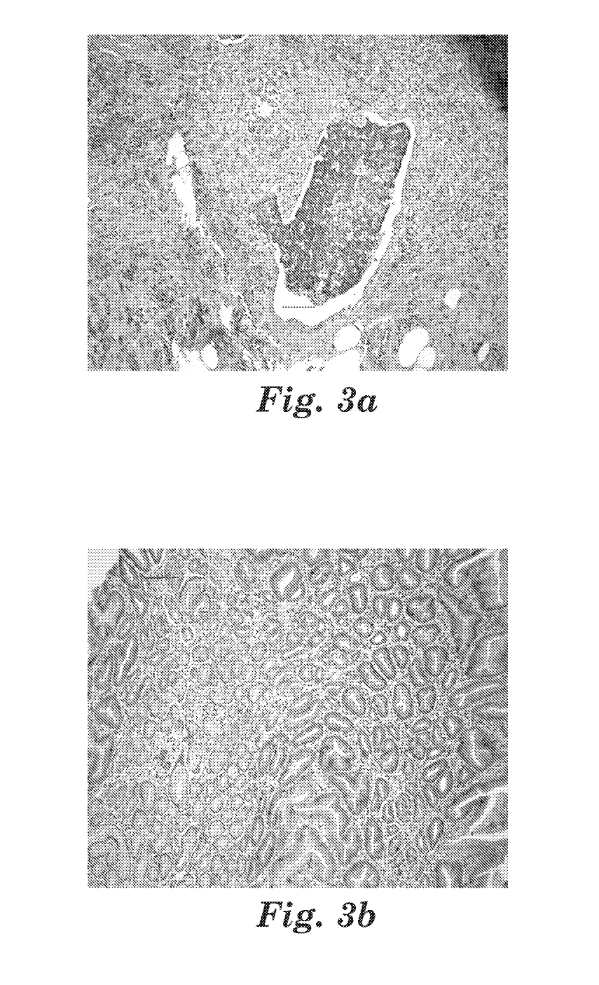

As shown in FIG. 1, both normal and malignant samples were available for case 3. Case 3 sections D1, D2 and B were obtained from stomach tissue with adenocarcinoma. Case 3 sections D5 and D6 originated from normal stomach tissue. FIGS. 3A and 3B are microscopic images at 100× magnification from samples taken from case 3. FIG. 3A illustrates a large cluster of malignant cells near the center of the image. The upper right corner contains a darker region demarcating the margin used for analysis. FIG. 3B originates from case 3, section D5 and represents normal stomach tissue.

The results of analysis and protein identification using the methods described herein on case 3 sections are shown in table 2. In the table, the tissue identity (cancer, normal, or common) is listed in the far left column. This is followed by the case, section, spot and protein identified. Proteins listed under “cancer” represent those proteins uniquely identified in the malignant sections tested for case 3. Likewise, proteins listed under “normal” were uniquely identified in the non-cancerous sections tested for case 3. “Common” describes those proteins found in both cancerous and normal sections tested for case 3.

TABLE 2
Proteins identified in case 3 sections tested

| Tissue | Case | Section | Spot | Protein |
|---|---|---|---|---|
| Cancer | 3 | B | 1 | acid fibroblast growth factor-like protein [Homo sapiens] |
| Cancer | 3 | B | 2 | acyl-Coenzyme A dehydrogenase family, member 8 [Mus musculus] |
| Cancer | 3 | D1 | 1 | ALKBH3 protein [Homo sapiens] |
| Cancer | 3 | B | 1 | Bip/GRP78 [Homo sapiens] |
| Cancer | 3 | D1 | 1 | casein kinase 2, beta polypeptide [Homo sapiens] |
| Cancer | 3 | D2 | 1 | caspase 1 [Rattus norvegicus] |
| Cancer | 3 | D2 | 1 | Chain A, Gppnhp-Bound Rab21 Gtpase At 2.50 A Resolution |
| Cancer | 3 | B | 1 | Chain A, Methylated Human O6-Alkylguanine-Dna Alkyltransferase |
| Cancer | 3 | B | 2 | Chain A, Structure Of A Helically Extended Sh3 Domain Of The T Cell Adapter Protein Adap |
| Cancer | 3 | B | 1 | CHD4 protein [Homo sapiens] |
| Cancer | 3 | D1 | 1 | chemokine-like factor superfamily 1 isoform 4 [Homo sapiens] |
| Cancer | 3 | D2 | 2 | circulating B cell antibody heavy chain variable region [Homo sapiens] |
| Cancer | 3 | B | 2 | collagenase 3 [Homo sapiens] |
| Cancer | 3 | D2 | 1 | C-type lectin protein CLL-1 [Homo sapiens] |
| Cancer | 3 | B | 2 | cyclin dependant kinase inhibitor [Sus scrofa] |
| Cancer | 3 | D2 | 2 | Cytochrome P450 19A1 (Aromatase) (CYPXIX) (Estrogen synthetase) (P-450AROM) |
| Cancer | 3 | D2 | 2 | deoxyuridine triphosphate nucleotidohydrolase, mitochondrial isoform [Homo sapiens] |
| Cancer | 3 | B | 2 | deoxyuridine triphosphate nucleotidohydrolase, mitochondrial isoform [Homo sapiens] |
| Cancer | 3 | D2 | 1 | dihydrouridine synthase 2-like, SMM1 homolog [Homo sapiens] |
| Cancer | 3 | D1 | 1 | down-regulated in metastasis [Homo sapiens] |
| Cancer | 3 | B | 1 | esophageal cancer associated protein [Homo sapiens] |
| Cancer | 3 | D1 | 1 | fibrinogen, beta polypeptide [Rattus norvegicus] |
| Cancer | 3 | D2 | 1 | FUBP1 protein [Homo sapiens] |
| Cancer | 3 | D1 | 1 | galactose-1-phosphate uridyl transferase |
| Cancer | 3 | D1 | 1 | galactose-1-phosphate uridyl transferase |
| Cancer | 3 | D1 | 2 | glycosyltransferase-like domain containing 1 isoform b [Homo sapiens] |
| Cancer | 3 | D2 | 1 | growth differentiation factor 7 [Homo sapiens] |
| Cancer | 3 | D1 | 2 | GT mitochondrial solute carrier protein homologue; putative |
| Cancer | 3 | D1 | 2 | guanine nucleotide exchange factor Lbc [Homo sapiens] |
| Cancer | 3 | B | 2 | Host cell factor-binding transcription factor Zhangfei (HCF-binding transcription factor Zhangfei) |
| Cancer | 3 | D1 | 1 | IFN-tyk, tyk2 = interferon alpha/beta signaling pathway-related protein |
| Cancer | 3 | D1 | 1 | IgM rheumatoid factor heavy chain VDJ region; IgM RF H chain VDJ region [Homo sapiens] |
| Cancer | 3 | D2 | 1 | keratin 9 [Homo sapiens] |
| Cancer | 3 | D2 | 1 | Keratin, type I cytoskeletal 9 (Cytokeratin-9) (CK-9) (Keratin-9) (K9) |
| Cancer | 3 | D2 | 2 | KIAA0219 [Homo sapiens] |
| Cancer | 3 | D1 | 1 | KIAA0229 [Homo sapiens] |
| Cancer | 3 | D2 | 1 | KIAA0423 protein [Homo sapiens] |
| Cancer | 3 | D1 | 1 | KIAA0444 protein [Homo sapiens] |
| Cancer | 3 | B | 1 | KIAA0444 protein [Homo sapiens] |
| Cancer | 3 | D2 | 1 | KIAA2007 protein [Homo sapiens] |
| Cancer | 3 | B | 2 | medulloblastoma antigen MU-MB-20.201 [Homo sapiens] |
| Cancer | 3 | D1 | 1 | meningioma expressed antigen 5 (hyaluronidase) [Homo sapiens] |
| Cancer | 3 | D1 | 2 | MHC cell surface glycoprotein |
| Cancer | 3 | D1 | 2 | MHC class I antigen [Homo sapiens] |
| Cancer | 3 | B | 2 | MHC class I antigen [Homo sapiens] |
| Cancer | 3 | D1 | 2 | MHC class I antigen HLA-B heavy chain [Homo sapiens] |
| Cancer | 3 | B | 2 | MHC class II antigen [Canis familiaris] |
| Cancer | 3 | D1 | 2 | MHC class II antigen [Homo sapiens] |
| Cancer | 3 | D2 | 2 | MHC class II antigen [Homo sapiens] |
| Cancer | 3 | B | 1 | MHC class II antigen HLA-DR-beta |
| Cancer | 3 | D1 | 1 | mitogen-activated protein kinase associated protein 1 [Homo sapiens] |
| Cancer | 3 | D1 | 1 | mono (ADP-ribosyl)transferase [Oryctolagus cuniculus] |
| Cancer | 3 | D1 | 2 | Myoglobin |
| Cancer | 3 | D2 | 2 | Myoglobin |
| Cancer | 3 | D1 | 2 | myosin IIIA [Homo sapiens] |
| Cancer | 3 | D2 | 1 | myosin, heavy polypeptide 1, skeletal muscle, adult [Mus musculus] |
| Cancer | 3 | D2 | 2 | Myosin-4 (Myosin heavy chain, skeletal muscle, juvenile) |
| Cancer | 3 | B | 1 | O-6-methylguanine-DNA methyltransferase [Homo sapiens] |
| Cancer | 3 | D1 | 1 | phosphorylase kinase alpha subunit liver isoform, PHKA2 {EC 2.7.1.38} |
| Cancer | 3 | D1 | 1 | platelet-derived growth factor receptor alpha precursor [Homo sapiens] |
| Cancer | 3 | B | 2 | PP1729 [Homo sapiens] |
| Cancer | 3 | B | 2 | PREDICTED: Cancer susceptibility candidate gene 5 protein |
| Cancer | 3 | D1 | 2 | PREDICTED: Prostate cancer gene 17 protein |
| Cancer | 3 | D1 | 2 | PREDICTED: similar to Cyclin G-associated kinase [Bos taurus] |
| Cancer | 3 | D2 | 1 | PREDICTED: similar to leucine rich repeat containing 34 [Bos taurus] |
| Cancer | 3 | D2 | 1 | PREDICTED: similar to Macrophage colony stimulating factor-1 precursor |
| Cancer | 3 | B | 2 | PREDICTED: similar to RAB17, member RAS oncogene family [Macaca mulatta] |
| Cancer | 3 | D2 | 2 | PREDICTED: similar to zinc finger protein 25 [Canis familiaris] |
| Cancer | 3 | D1 | 1 | PTPL1-associated RhoGAP [Homo sapiens] |
| Cancer | 3 | D2 | 1 | RAB21, member RAS oncogene family [Homo sapiens] |
| Cancer | 3 | D1 | 2 | RAB37, member RAS oncogene family isoform 2 [Homo sapiens] |
| Cancer | 3 | D2 | 1 | RAB37, member RAS oncogene family isoform 3 [Homo sapiens] |
| Cancer | 3 | B | 2 | RAB6A, member RAS oncogene family [Mus musculus] |
| Cancer | 3 | B | 2 | Rabphilin-3A (Exophilin-1) |
| Cancer | 3 | D1 | 2 | Rho GTPase activating protein 21 [Mus musculus] |
| Cancer | 3 | B | 1 | rho/rac-interacting citron kinase short isoform [Mus musculus] |
| Cancer | 3 | B | 2 | Ribosomal protein S6 kinase-like 1 |
| Cancer | 3 | D1 | 2 | semaphorin 3A precursor [Homo sapiens] |
| Cancer | 3 | B | 1 | Sentrin-specific protease 6 (Sentrin/SUMO-specific protease SENP6) (SUMO-1-specific protease 1) |
| Cancer | 3 | B | 1 | Squamous cell carcinoma antigen recognized by T-cells 3 (SART-3) |
| Cancer | 3 | D1 | 1 | sterol carrier protein-2 |
| Cancer | 3 | D1 | 1 | suppressor of cytokine signaling 3 [Homo sapiens] |
| Cancer | 3 | D1 | 2 | syntaxin 6 [Homo sapiens] |
| Cancer | 3 | D1 | 2 | T cell receptor beta [Sus scrofa] |
| Cancer | 3 | D1 | 2 | TBC1 domain family, member 3B [Homo sapiens] |
| Cancer | 3 | D2 | 1 | T-cell receptor alpha chain [Rattus norvegicus] |
| Cancer | 3 | D1 | 2 | T-cell receptor alpha-chain V region [Homo sapiens] |
| Cancer | 3 | D1 | 2 | thioesterase domain containing 1 [Mus musculus] |
| Cancer | 3 | B | 2 | Transferrin [Homo sapiens] |
| Cancer | 3 | B | 2 | transforming growth factor beta regulated gene 4 [Rattus norvegicus] |
| Cancer | 3 | B | 2 | tumor necrosis factor-alpha-induced protein B12 - human |
| Cancer | 3 | D1 | 2 | zinc finger protein 286 [Homo sapiens] |
| Cancer | 3 | B | 1 | zinc finger protein 286 [Homo sapiens] |
| Cancer | 3 | D2 | 1 | Zinc finger protein 29 (Zinc finger protein KOX26) |
| Cancer | 3 | B | 1 | zinc finger protein 291 [Homo sapiens] |
| Cancer | 3 | D2 | 2 | zinc finger protein 519 variant [Homo sapiens] |
| Cancer | 3 | D2 | 2 | ZNF266 protein [Homo sapiens] |
| Cancer | 3 | D2 | 1 | ZNF266 protein [Homo sapiens] |
| Common | 3 | D6, 3B | 2 | 5′-3′ exoribonuclease 2 isoform 3 [Homo sapiens] |
| Common | 3 | D5, 3B | 2 | ARF GTPase-activating protein GIT1 [Homo sapiens] |
| Common | 3 | D2, 3D5 | 1 | G protein-coupled receptor kinase 6 [Homo sapiens] |
| Common | 3 | D1, 3D6 | 2 | macrophage colony-stimulating factor, M-CSF |
| Common | 3 | B, 3D6 | 1 | PREDICTED: similar to chromodomain helicase DNA binding protein |
| Normal | 3 | D6 | 1 | angiopoietin 4 [Homo sapiens] |
| Normal | 3 | D6 | 2 | breast cancer antigen NY-BR-1 [Homo sapiens] |
| Normal | 3 | D6 | 1 | CASK-interacting protein CIP98 [Homo sapiens] |
| Normal | 3 | D6 | 2 | colony stimulating factor 1 (macrophage) [Homo sapiens] |
| Normal | 3 | D6 | 2 | DHX8 protein [Homo sapiens] |
| Normal | 3 | D5 | 2 | feline sarcoma oncogene [Mus musculus] |
| Normal | 3 | D5 | 2 | GIT1 protein [Homo sapiens] |
| Normal | 3 | D6 | 2 | HLA-B |
| Normal | 3 | D6 | 1 | leucine rich repeat containing 2 [Homo sapiens] |
| Normal | 3 | D5 | 2 | MAGEB1/2 [Mus musculus] |
| Normal | 3 | D5 | 2 | melanoma antigen, family B, 1 [Mus musculus] |
| Normal | 3 | D6 | 2 | MHC HLA-DQ-beta cell surface glycoprotein |
| Normal | 3 | D6 | 1 | Peg3 protein [Mus musculus] |
| Normal | 3 | D6 | 2 | PREDICTED: similar to DEAH (Asp-Glu-Ala-His) box polypeptide 8 isoform 3 [Canis familiaris] |
| Normal | 3 | D6 | 1 | PREDICTED: similar to Gastric triacylglycerol lipase precursor (Gastric lipase) (GL) [Mus musculus] |
| Normal | 3 | D6 | 2 | PREDICTED: similar to neural precursor cell expressed, developmentally down-regulated 1 [Canis familiaris] |
| Normal | 3 | D6 | 2 | PREDICTED: similar to Zinc finger protein 624, partial [Macaca mulatta] |
| Normal | 3 | D6 | 2 | Rab-coupling protein [Homo sapiens] |
| Normal | 3 | D6 | 1 | rheumatoid factor RF-ET10 [Homo sapiens] |
| Normal | 3 | D5 | 2 | SLAMF1 protein [Homo sapiens] |
| Normal | 3 | D6 | 1 | spindle pole body protein [Homo sapiens] |

Table 2 thus provides a listing of proteins uniquely identified in gastric adenocarcinoma tissue samples (the “cancer” sublisting) via the methods described herein that may be used as potential biomarkers for this disease. Furthermore, the presence of such biomarkers in tissue samples of unknown biological status (for example, cancer status unknown) may also be used in risk assessment for gastric adenocarcinoma and the like.

### Example 2

### H. pylori and Gastric Cancer Formalin-Fixed Paraffin Embedded Mass Spectrometry

### Identification of Biomarkers and Use Therein

Using the antigen retrieval and mass spectrometry methods described in Example 1, proteins are identified for each of the following biological classes according to the scheme below:

Class Set A=patient population with known diagnosis of gastric cancer.
Class A1 (a member of Class Set A)=subpopulation with additionally known diagnosis of H. pylori infection
Class A2 (a member of Class Set A)=subpopulation with no known diagnosis of H. pylori infection

Class Set B=patient population with no known diagnosis of gastric cancer.
Class B1 (a member of Class Set B)=subpopulation with known diagnosis of H. pylori infection
Class B2 (a member of Class Set B)=subpopulation with no known diagnosis of H. pylori infection

Using the methods described herein, proteins in each of the four biological classes noted above are identified. Proteins present in one or more of classes A1, A2, or B1, but not in class B2 may be used as biomarkers associated with a disorder of the gastrointestinal tract where that disorder is gastric cancer, H. pylori infection, or both conditions. Future samples with an unknown gastric cancer and/or H. pylori infection status may be screened using the methods described herein and, upon identification of one or more proteins found in one or more of classes A1, A2 or B1 (but not present in B2), may be labeled as having an increased risk for the development of gastric cancer and/or an increased risk for the emergence of symptoms of H. pylori infection. Proteins in class A1 that are not present in any of classes A2, B1 or B2 may be used as biomarkers associated with both H. pylori infection and gastric cancer. Future samples with an unknown malignancy status, but where H. pylori infection is known, may be screened using the methods described herein and, upon identification of one or more proteins unique to class A1, may be labeled as having an increased risk for the development of gastric cancer.

The complete disclosures of the patents, patent documents, and publications cited herein are incorporated by reference in their entirety as if each were individually incorporated. Various modifications and alterations to this invention will become apparent to those skilled in the art without departing from the scope and spirit of this invention. It should be understood that this invention is not intended to be unduly limited by the illustrative embodiments set forth herein and that such embodiments are presented by way of example only, with the scope of the invention intended to be limited only by the claims.

What is claimed is:

1. A method for identification of biomarkers associated with one or more gastrointestinal disorder comprising:
i) providing one or more gastrointestinal cellular samples comprising chemically crosslinked analytes, wherein the samples are embedded in an organic solid material and at least one sample is from a patient with one or more gastrointestinal disorder;
ii) reversing at least a portion of the chemical crosslinks in the crosslinked analytes to form decrosslinked analytes;
iii) generating mass spectra of at least a portion of the samples containing the decrosslinked analytes; and
iv) analyzing the mass spectra using a digital computer, wherein the method of analyzing the mass spectra comprises:
a) entering into the digital computer a data set obtained from mass spectra from a plurality of cellular samples, wherein each sample is, or is to be assigned to a class within a class set comprising two or more classes, each class characterized by a different biological status, and wherein each mass spectrum comprises data representing signal strength as a function of time-of-flight, mass-to-charge ratio, or a value derived from time-of-flight or mass-to-charge ratio; and
b) forming a classification model which discriminates between the classes in the class set, wherein forming comprises analyzing the data set by executing code that embodies a classification process comprising a recursive partitioning process, which is a classification and regression tree process; and
v) identifying biomarkers associated with one or more gastrointestinal disorder as those data unique to classes where the biological status includes a gastrointestinal disorder.

2. A method for providing a risk assessment for developing one or more gastrointestinal disorder comprising:
i) providing one or more gastrointestinal cellular samples comprising chemically crosslinked analytes, wherein the samples are embedded in an organic solid material and wherein one or more samples has/have an unknown biological status;
ii) reversing at least a portion of the chemical crosslinks in the crosslinked analytes to form decrosslinked analytes;
iii) generating mass spectra of at least a portion of the samples containing the decrosslinked analytes; and
iv) analyzing the mass spectra using a digital computer;
v) evaluating the one or more samples with an unknown biological status for the presence of biomarkers associated with disorders of the gastrointestinal tract;
vi) identifying those samples with one or more such biomarkers as samples with an increased risk for one or more gastrointestinal disorder.

3. The method of claim 1, wherein the one or more gastrointestinal disorder is one or more selected from the group consisting of H. pylori infection, gastritis, peptic ulcer, duodenal ulcer, and gastric cancer.

4. The method of claim 3, wherein the gastric cancer is one or more selected from the group consisting of non-cardia gastric cancer, cardia gastric cancer, and MALT lymphoma.

5. The method of claim 2, wherein the one or more gastrointestinal disorder is one or more selected from the group consisting of H. pylori infection, gastritis, peptic ulcer, duodenal ulcer, and gastric cancer.

6. The method of claim 5, wherein the gastric cancer is one or more selected from the group consisting of non-cardia gastric cancer, cardia gastric cancer, and MALT lymphoma.

7. The method of claim 1, wherein the one or more gastrointestinal disorder includes H. pylori infection.

8. The method of claim 2, wherein the one or more gastrointestinal disorder includes H. pylori infection.

9. The method of claim 1, wherein the one or more gastrointestinal disorder includes gastric cancer.

10. The method of claim 2, wherein the one or more gastrointestinal disorder includes gastric cancer.
